(19) United States
(12) Patent Application Publication
(10) Pub. No.: US 2019/0228037 A1
(43) Pub. Date: Jul. 25, 2019

(54) CHECKPOINTING DATA FLOW GRAPH COMPUTATION FOR MACHINE LEARNING

(71) Applicant: Wave Computing, Inc., Campbell, CA (US)

(72) Inventors: Christopher John Nicol, Campbell, CA (US); Keith Mark Evans, San Jose, CA (US); Mehran Ramezani, Laguna Niguel, CA (US)

(21) Appl. No.: 16/369,079

(22) Filed: Mar. 29, 2019

Related U.S. Application Data
(63) Continuation-in-part of application No. 16/104,586, filed on Aug. 17, 2018.
(60) Provisional application No. 62/802,307, filed on Feb. 7, 2019.
(60) Provisional application No. 62/800,432, filed on Feb. 2, 2019.
(60) Provisional application No. 62/773,486, filed on Nov. 30, 2018.
(60) Provisional application No. 62/694,984, filed on Jul. 7, 2018.
(60) Provisional application No. 62/692,993, filed on Jul. 2, 2018.
(60) Provisional application No. 62/679,046, filed on Jun. 1, 2018.
(60) Provisional application No. 62/679,172, filed on Jun. 1, 2018.
(60) Provisional application No. 62/650,425, filed on Mar. 30, 2018.
(60) Provisional application No. 62/650,758, filed on Mar. 30, 2018.
(60) Provisional application No. 62/637,614, filed on Mar. 2, 2018.
(60) Provisional application No. 62/636,309, filed on Feb. 28, 2018.
(60) Provisional application No. 62/611,600, filed on Dec. 29, 2017.
(60) Provisional application No. 62/611,588, filed on Dec. 29, 2017.
(60) Provisional application No. 62/594,563, filed on Dec. 5, 2017.
(60) Provisional application No. 62/594,582, filed on Dec. 5, 2017.
(60) Provisional application No. 62/579,616, filed on Oct. 31, 2017.
(60) Provisional application No. 62/577,902, filed on Oct. 27, 2017.
(60) Provisional application No. 62/547,769, filed on Aug. 19, 2017.

(51) Int. Cl. G06F 16/901; G06N 20/00

(52) U.S. Cl. CPC G06F 16/9024; G06N 20/00

(57) ABSTRACT

Techniques are disclosed for checkpointing data flow graph computation for machine learning. Processing elements within a reconfigurable fabric are configured to implement a data flow graph. Nodes of the data flow graph can include variable nodes. The processing elements are loaded with process agents. Valid data is executed by a first process agent. The first process agent corresponds to a starting node of the data flow graph. Invalid data is sent to the first process agent. The invalid data initiates a checkpoint operation for the data flow graph. Invalid data is propagated from the starting node of the data flow graph to other nodes within the data flow graph. The variable nodes are paused upon receiving invalid data. Paused variable nodes within the data flow graph are restarted by issuing a run command, and valid data is sent to the starting node of the data flow graph.

### RELATED APPLICATIONS

This application claims the benefit of U.S. provisional patent applications “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, “Data Flow Graph Computation Using Exceptions” Ser. No. 62/694,984, filed Jul. 7, 2018, “Reconfigurable Fabric Configuration Using Spatial and Temporal Routing” Ser. No. 62/773,486, filed Nov. 30, 2018, “Machine Learning for Voice Calls Using a Neural Network on a Reconfigurable Fabric” Ser. No. 62/800,432, filed Feb. 2, 2019, and “FIFO Filling Logic for Tensor Calculation” Ser. No. 62/802,307, filed Feb. 7, 2019.

This application is also a continuation-in-part of “Reconfigurable Fabric Data Routing” Ser. No. 16/104,586, filed Aug. 17, 2018, which claims the benefit of U.S. provisional patent applications “Reconfigurable Fabric Data Routing” Ser. No. 62/547,769, filed Aug. 19, 2017, “Tensor Manipulation Within a Neural Network” Ser. No. 62/577,902, filed Oct. 27, 2017, “Tensor Radix Point Calculation in a Neural Network” Ser. No. 62/579,616, filed Oct. 31, 2017, “Pipelined Tensor Manipulation Within a Reconfigurable Fabric” Ser. No. 62/594,563, filed Dec. 5, 2017, “Tensor Manipulation Within a Reconfigurable Fabric Using Pointers” Ser. No. 62/594,582, filed Dec. 5, 2017, “Dynamic Reconfiguration With Partially Resident Agents” Ser. No. 62/611,588, filed Dec. 29, 2017, “Multithreaded Dataflow Processing Within a Reconfigurable Fabric” Ser. No. 62/611,600, filed Dec. 29, 2017, “Matrix Computation Within a Reconfigurable Processor Fabric” Ser. No. 62/636,309, filed Feb. 28, 2018, “Dynamic Reconfiguration Using Data Transfer Control” Ser. No. 62/637614, filed Mar. 2, 2018, “Data Flow Graph Computation for Machine Learning” Ser. No. 62/650,758, filed Mar. 30, 2018, “Checkpointing Data Flow Graph Computation for Machine Learning” Ser. No. 62/650,425, filed Mar. 30, 2018, “Data Flow Graph Node Update for Machine Learning” Ser. No. 62/679,046, filed Jun. 1, 2018, “Dataflow Graph Node Parallel Update for Machine Learning” Ser. No. 62/679,172, filed Jun. 1, 2018, “Neural Network Output Layer for Machine Learning” Ser. No. 62/692,993, filed Jul. 2, 2018, and “Data Flow Graph Computation Using Exceptions” Ser. No. 62/694,984, filed Jul. 7, 2018.

Each of the foregoing applications is hereby incorporated by reference in its entirety.

### FIELD OF ART

This application relates generally to data manipulation and more particularly to checkpointing data flow graph computation for machine learning.

### BACKGROUND

Researchers, business people, and governments collect and analyze vast amounts of data. The data is most typically collected from people as they interact with their personal and other electronic devices. The interactions can be online, in public, or at home. The collection of public, personal, and other data has become so commonplace that the collection frequently goes unnoticed until there is a problem. An individual may be using her smartphone to research world events, while another person is using his tablet to order pet food or toner cartridges. Irrespective of the particular activity, metadata is collected about the user interactions with their devices. Data and metadata includes details such as websites visited, products and services searched or viewed, and radio buttons clicked. All of this data is collected and analyzed for purposes of monetization, security, or surveillance, among others. Analysis results are used to push online content, products, or services that are predicted to match user interests.

Emerging software analysis techniques and processor architectures are propelling the collection of personal and other data at an accelerating rate. Businesspeople, researchers, and governments aggregate the collected data into datasets that are often referred to as “big data”. The big data datasets can then be analyzed. The sizes of the big data datasets overwhelm the capabilities of the traditional processors and analysis techniques, making the analysis economically infeasible. Other data handling requirements further complicate the computational and processing requirements such as the access, capture, maintenance, storage, transmission, and visualization of the data, among other tasks. Any one of these data handling requirements can quickly saturate or exceed the capacities of the traditional systems. The collected data fundamentally would be of little or no value without viable and scalable data analysis and handling techniques. Innovative computing architectures, plus software techniques, algorithms, functions, routines, and heuristics, are necessitated. Dataset stakeholders are motivated by business, research, and other interests to analyze the data. Common data analysis purposes include business analysis; disease or infection detection, tracking, and control; crime detection and prevention; meteorology; and complex scientific and engineering simulations, among many others. Advanced data analysis techniques are finding applications such as predictive analytics, which can be used to show consumers what they want, even before the consumers know that they want it. Further approaches include applying machine learning and deep learning techniques in support of the data analysis.

Advanced processing hardware has been introduced, as have software learning techniques, which have been a boon to many computer science disciplines including machine learning. Machine learning posits that a machine on its own can “learn” about a unique dataset. The machine learning occurs without the machine having to be explicitly coded or programmed by a user to handle that dataset. Machine learning can be performed on a network of processors such as a neural network. The neural network can process the big data datasets so that the neural network can learn about the data contained within the dataset. The greater the quantity of data, and the higher the quality of the data that is processed, the better the outcome of the machine learning. The processors on which the machine learning techniques can be executed are designed to efficiently handle the flow of data. These processors, which are based on data flow architectures, process data when valid data is presented to the processor. Data flow architectures enable simplifications to a processing system such as avoiding a need for a global system clock.

Computing architectures based on reconfigurable hardware are highly flexible and particularly well suited to processing large data sets, performing complex computations, and executing other computationally resource-intensive applications. Reconfigurable computing integrates the key advantages drawn from hardware and software techniques. A reconfigurable computing architecture can be “recoded” (reprogrammed) to suit a processing need. The recoding adapts or configures the high-performance hardware architecture, much like recoding software. A reconfigurable fabric hardware technique is directly applicable to reconfigurable computing. Reconfigurable fabrics may be arranged in topologies or configurations for the many applications that require high performance computing. Applications such as processing of big data, digital signal processing (DSP), machine learning based on neural networks, matrix or tensor computations, vector operations, or Boolean manipulations, and so on, can be implemented within a reconfigurable fabric. The reconfigurable fabric fares particularly well when the data includes specific types of data, large quantities of unstructured data, sample data, training data, and the like. The reconfigurable fabrics can be coded or scheduled to achieve these and other processing techniques, and to represent a variety of efficient computer architectures.

### SUMMARY

A data flow graph is used to represent the processing of data for a given computational task. The data flow graph illustrates the flow of data through a computational architecture, and the operations that are performed on the data. A given data flow graph is especially well suited to representing a variety of complex computational tasks and to understanding the calculations and flow of data required to perform those tasks. Machine learning is one particularly appropriate computational example that can be well represented using a data flow graph. Machine learning is a technique by which a computing system, based on a computer architecture such as a reconfigurable fabric, can “learn”. That is, the computing system adapts itself or “learns” over time based on training of the system. The training results from analyzing large amounts of data. The more data that is analyzed, the better the training. The training enables improved inferences relating to the data, better computational performance in analyzing the data, and so on. Machine learning systems can be based on neural networks such as convolutional neural networks (CNN), deep neural networks, (DNN), recurrent neural networks (RNN), and so on.

A reconfigurable fabric can be configured or “coded” to implement a given data flow graph. The reconfigurable fabric can be adapted or “recoded” based on the machine learning or deep learning. The data flow graph itself can be adapted by changing code used to configure elements of the reconfigurable fabric, parameters or values such as weights, biases, or parameters processed by the data flow graph, etc. The reconfigurable fabric can include computational or processor elements, storage elements, switching elements for data transfer, control elements, communications paths, and so on. The reconfigurable fabrics are coded to implement a variety of processing topologies that support the machine learning. The reconfigurable fabric can be configured by coding or scheduling the reconfigurable fabric to execute a variety of logical operations such as Boolean operations, matrix operations, tensor operations, mathematical operations, logical operations, etc. The scheduling of the reconfigurable fabric can be changed based on a data flow graph.

Checkpointing data flow graph computation is performed for machine learning. Embodiments include a processor-implemented method for data manipulation comprising: configuring a plurality of processing elements within a reconfigurable fabric to implement a data flow graph; loading the plurality of processing elements with a plurality of process agents; executing valid data by a first process agent, wherein the first process agent corresponds to a starting node of the data flow graph; and sending invalid data to the first process agent, wherein the invalid data initiates a checkpoint operation for the data flow graph. The invalid data is propagated from the starting node of the data flow graph to other nodes within the data flow graph. Each variable node within the data flow graph is paused upon receipt of invalid data. Variable nodes within the data flow graph that are paused are restarted by issuing a run command to all variable nodes that are paused. Further, valid data is sent to the starting node of the data flow graph.

Various features, aspects, and advantages of various embodiments will become more apparent from the following further description.

### BRIEF DESCRIPTION OF THE DRAWINGS

The following detailed description of certain embodiments may be understood by reference to the following figures wherein:

FIG. 1 is a flow diagram for checkpointing data flow graph computation for machine learning.

FIG. 2 is a flow diagram for data flow graph checkpoint operation.

FIG. 3 shows execution manager operation.

FIG. 4 shows a network for a data flow graph.

FIG. 5 illustrates a deep learning program graph.

FIG. 6 shows an assembled data flow graph for runtime.

FIG. 7 illustrates batch processing for training.

FIG. 8 shows a cluster for coarse-grained reconfigurable processing.

FIG. 9 shows a block diagram of a circular buffer.

FIG. 10 illustrates circular buffers and processing elements.

FIG. 11 shows a deep learning block diagram.

FIG. 12 is a system diagram for checkpointing data flow graph computation for machine learning.

### DETAILED DESCRIPTION

Techniques are disclosed for checkpointing data flow graph computation for machine learning. There are many reasons for data flow graph computations to be checkpointed. For example, a higher priority data flow graph may need to be run, or a computational time limit may have been reached, or existing neural network weights may need to be updated, to name just a few. To initiate a checkpoint operation, invalid data can be used to perform a valid and important signaling function. After valid data has been operated on by a first process agent resident on a starting node of a data flow graph, invalid data can be sent to the first process agent. The invalid data can initiate a checkpoint operation for the data flow graph. The invalid data can propagate through the data flow graph to prepare and initialize the nodes of the data flow graph for checkpointing and subsequent restarting. Checkpointing is a computing device process by which a machine or submachine within the computing device has its pertinent data and states unloaded/stored for future use and analysis. Disclosed techniques are particularly useful for a data flow graph implemented on a reconfigurable fabric.

Data flow graph computations can be performed on a computing device, a reconfigurable computing device, and so on. A reconfigurable fabric is one such reconfigurable computing device that incorporates features of hardware techniques and software techniques. The hardware techniques include computer architectures designed for high performance computations. The included software techniques enable the hardware to be reconfigured easily for specific computational tasks such as machine learning.

A reconfigurable fabric can include one or more element types, where the element types can include processing elements, storage elements, switching elements, and so on. An element can be configured to perform a variety of architectural and computational operations based on the type of element and by programming or “scheduling” the element. The reconfigurable fabric can include quads of elements, where the quads include processing elements, shared storage elements, switching elements, circular buffers for control, communications paths, and the like. An element or subset of elements within the reconfigurable fabric, such as a quad of elements, can be controlled by providing code to one or more circular buffers. The code can be executed by enabling the circular buffers to rotate. Code can also be provided to elements within the reconfigurable fabric so that the reconfigurable fabric can perform intended computational tasks such as logical operations, matrix computations, tensor operations, mathematical operations, etc. The various elements of the reconfigurable fabric can be controlled by the rotating circular buffers, where the one or more circular buffers can be of the same lengths or differing lengths. Functions, algorithms, instructions, codes, etc., can be loaded into a given circular buffer. The rotation of the given circular buffer ensures that the same series of coded steps or instructions is repeated as required by the processing tasks assigned to a processing element of the reconfigurable fabric. The one or more rotating circular buffers can be statically scheduled.

Machine learning uses data flow graph computation. A data flow graph includes nodes that perform computations and arcs that indicate the flow of data between and among the nodes. A plurality of processing elements within a reconfigurable fabric configured to implement a data flow graph. The reconfigurable fabric can include other elements such as storage elements, switching elements, or communications paths. The reconfigurable fabric can be self-clocked on a hum basis. The plurality of processing elements is loaded with a plurality of process agents. The process agents can perform operations of one or more nodes of the data flow graph. A first set of buffers for a first process agent is initialized, wherein the first process agent corresponds to a starting node of the data flow graph. The input buffers can be located within the reconfigurable fabric or coupled to the reconfigurable fabric. The buffers can include hybrid memory cubes. A fire signal is issued for the starting node, based on the first set of buffers being initialized. The fire signal can originate from an execution manager. The execution manager can be located on a computing device that is in communication with the reconfigurable fabric. Embodiments include initializing a second set of buffers for a second process agent, where the second process agent corresponds to a successor node of the data flow graph. The successor node can be one of multiple successor nodes, an output node, etc. Results of operations can be collected by a further process agent following receipt of the fire signal. Collecting the results of operations can include receiving a pointer to the results. The further process agent can process results of operations from the first agent, test data, sample data, biases, weights, and the like. Further embodiments include issuing a fire signal for the successor node, based on the first agent completing issuing a done signal.

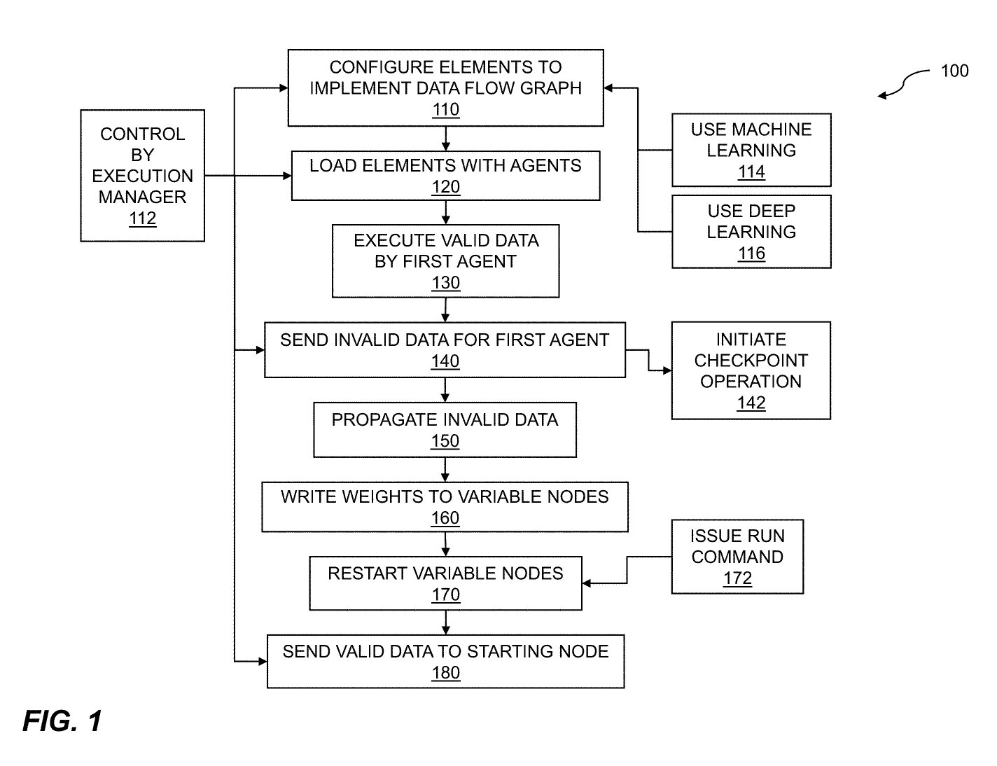

FIG. 1 is a flow diagram for checkpointing data flow graph computation for machine learning. The flow 100 includes configuring a plurality of processing elements within a reconfigurable fabric to implement a data flow graph 110. The data flow graph includes nodes and arcs, where the nodes can correspond to operations, and the arcs to flows of data. In embodiments, a set of nodes within the data flow graph comprise variable nodes. Parameters of the variable nodes can be adjusted, where the adjusting can be performed to improve data flow graph performance, convergence, and so on. In embodiments, the variable nodes contain weights and are used for machine learning 114 or deep learning 116. In embodiments, the weights are updated during operation of the data flow graph. In embodiments, updating the weights comprises back-annotation. The weights for deep learning can be adjusted. The reconfigurable fabric can include clusters of processing elements, where the clusters of processing elements can include quads of processing elements. The reconfigurable fabric can include other types of elements such as storage elements, switching elements, and so on. In embodiments, the processing elements can be controlled by circular buffers. The circular buffers can include rotating circular buffers. The configuring of the processing elements can be accomplished by scheduling or loading commands, instructions, code, etc., into the circular buffers. In embodiments, the circular buffers can be statically scheduled. The data flow graph can include deep learning, where the deep learning can be performed by a deep learning network. The data flow graph can include machine learning. In embodiments, the data flow graph can be used to train a neural network. The data flow graph can represent neural network such as a deep neural network (DNN), a convolutional neural network (CNN), and the like. In other embodiments, the neural network can include a recurrent neural network (RNN).

The flow 100 includes loading the plurality of processing elements with a plurality of process agents 120. The process agents can be loaded onto the processing elements by scheduling the circular buffers, such as rotating circular buffers, as described above. The process agents that can be loaded can include the agents from the entire data flow graph, a subgraph from a partitioned version of the data flow graph, and so on. The agents can be loaded onto processing elements, where the processing elements may have been vacated by a previously executed data flow graph. In embodiments, the plurality of processing elements within the reconfigurable fabric can be reconfigured, where the reconfiguring can include swapping and reloading agents, nodes, etc. The reconfiguration can result from swapping out a data flow graph or a data flow sub-graph, swapping out agents, etc. In embodiments, the reconfiguring and the loading can be controlled by a session manager.

The flow 100 includes executing valid data by a first process agent 130. The first process agent can correspond to a starting node of the data flow graph, an input node of the data flow graph, etc. The first set of buffers can be initialized by with valid data. The valid data can include test data, sample data, weights, bias values, and so on. The valid data can include matrices, tensors, image data, audio data, and the like. In embodiments, the initializing is controlled by an execution manager 112. The execution manager can perform tasks that support execution of the data flow graph. The tasks that can be performed by the execution manager can include providing data to input agents of the data flow graph, collecting output data from output agents, issuing fire signals to agents and receiving done signals from agents, pausing and restarting data flow graph execution, and the like. The execution manager can be loaded onto a computing device, where the computing device can be in communication with the reconfigurable fabric. The execution manager can be resident in a host computer apart from the reconfigurable fabric. In embodiments, the host computer can communicate with the reconfigurable fabric using a PCIe interface.

The flow 100 includes sending invalid data for the first agent 140, which is resident on the starting node. The invalid data can initiate a checkpoint operation 142 for the data flow graph. Computation by the agents of the data flow graph within the reconfigurable fabric can be paused and restarted as part of the checkpoint operation. The invalid data can comprise an invalid state in logic that employs invalid states, such as NCL, an invalid bit being sent as part of a data packet, and so on. In embodiments, the invalid data comprises an invalid state of NCL logic. The invalid data can include ill-formed numbers, matrices with zero rows and zero columns, special characters, reserved values, invalid pointers, and so on. The invalid data can be a data tensor with an invalid bit being set. The invalid data can propagate 150 through the data flow graph and cause each node to stop processing. As invalid data reaches each variable node within the data flow graph, that is, the nodes that are performing neural network computations using weights, each variable node can be paused. As discussed above, the execution manager can process fire signals and done signals, provide data, read weights for a layer of a deep learning network, write weights, and so on. Further embodiments include initializing a second set of buffers for a second process agent (not shown), where the second process agent corresponds to a successor node of the data flow graph. The second process agent can process data that is output by the first agent, other data such as weights, back-annotated weight adjustments, biases, and so on.

As previously mentioned, checkpointing is a computing device process by which a machine or submachine within the computing device has it pertinent data and states unloaded/stored for future use and analysis. For the processing elements of a reconfigurable fabric loaded with agents supporting execution of a data flow graph, checkpointing can include reading out all pertinent weight information for a neural network variable node. A variable node can have its weights updated based on the data flowing through it during normal operation. If another agent needs to be run, then the variable node weights can be saved for later reloading and restarting of the originally-running kernel. In order to checkpoint the variable nodes cleanly, they are all transitioned to a paused state, and a snapshot of the weights, which can be contained in buffers, is taken. Subsequent restarting of the operation of the agent's (or agents') is now enabled by reloading the checkpointed data and agent(s) and starting computation by the original agent(s) of the data flow graph again. Thus checkpointing refers to performing a checkpoint operation in a reconfigurable fabric as described herein. In embodiments, the checkpoint operation includes storing variable node weights in storage outside of the reconfigurable fabric. In embodiments, the weights are stored in variable node buffers. In embodiments, the checkpoint operation is managed by an execution manager.

The flow 100 includes writing weights back out to the variable nodes 160. The new or updated weights can be for resumption of an original data flow graph or subgraph or for the start of a new data flow graph or subgraph. Once all of the variable nodes have valid data written into them, such as updated or new weight data, the variable nodes can be restarted 170. The restarting of the variable nodes can be the result of issuing a run command 172. The flow 100 can include sending valid data to the starting node 180. The first process agent, resident in the starting node, can consume valid data from the first set of buffers as the first process agent processes that data. When the quantity of data in the first set of buffers has been fully consumed, the first agent can indicate that it is “done” with the first set of buffers by issuing a done signal. The execution manager can provide further data to the first process agent by sending valid data to the first set of buffers. The execution manager can send a further fire signal to the first process agent to indicate that the further data in the first set of buffers is ready for processing. The issuing of the fire signal to the successor node can be based on the first agent completing issuing a done signal. The done signal from the first agent can further indicate that its one or more output buffers are full, the buffers contain all of the output data, the data that can be required for the successor node is available for processing, or the like. In embodiments, the done signal can indicate valid data present in the second set of buffers. In like manner, valid data now propagates through the data flow graph, and the function implemented on the data flow graph is accomplished. In embodiments, the data flow graph is accomplished using machine learning. In embodiments, the data flow graph is accomplished using deep learning. Various steps in the flow 100 may be changed in order, repeated, omitted, or the like without departing from the disclosed concepts. Various embodiments of the flow 100 can be included in a computer program product embodied in a non-transitory computer readable medium that includes code executable by one or more processors.

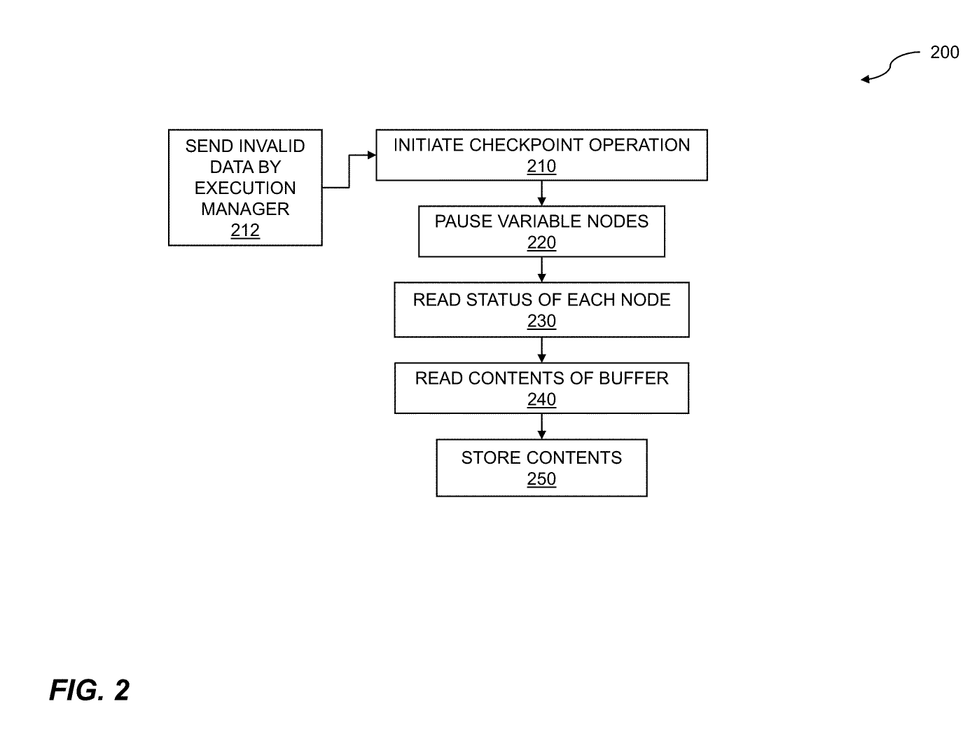

FIG. 2 is a flow diagram for data flow graph checkpoint operation. A data flow graph can be used to represent processing of data as the data flows among nodes of the graph. The nodes, which can be represented by agents, processing elements, and so on, can perform a variety of computations such as logical operations, matrix manipulations, tensor operations, Boolean operations, mathematical computations, and so on. Data flow graph computations can be performed for machine learning. The data flow computations can be performed within a reconfigurable fabric. A plurality of processing elements within a reconfigurable fabric is configured to implement a data flow graph. The plurality of processing elements is loaded with a plurality of process agents. Valid data is executed by a first process agent. The first process agent corresponds to a starting node of the data flow graph. Invalid data is sent to the first process agent. The invalid data initiates a checkpoint operation for the data flow graph. Computation by the agents of the data flow graph within the reconfigurable fabric can be paused and restarted as part of the checkpoint operation.

The flow 200 includes initiating a checkpoint operation 210. The checkpoint operation initiation can be started by sending invalid data by the execution manager 212 to the starting node of a data flow graph. The invalid data can comprise an invalid state in logic that employs invalid states, such as NCL, an invalid bit being sent as part of a data packet, and so on. The invalid data can include ill-formed numbers, matrices with zero rows and zero columns, special characters, reserved values, invalid pointers, and so on. The invalid data can be a data tensor with an invalid bit being set. The invalid data can propagate through the data flow graph and cause each node to stop processing. As invalid data reaches each variable node within the data flow graph, that is, the nodes that are performing neural network computations using weights, each variable node can be paused 220, i.e. put into a paused state. Note that to execute a data flow graph, the data flow graph may be partitioned into subgraphs. The data flow graph can be paused due to the need to execute a higher priority agent, a higher priority subgraph, an amount of time such as processing time has elapsed, and so on. In embodiments, the pausing is controlled by an execution manager 212. The execution manager can control processing and monitoring of control signals such as fire and done signals. The execution manager can control the flow of data among the nodes of the data flow graph. In other embodiments, the pausing can be accomplished by withholding new data from entering the data flow graph. Recall that a data flow processor operates on data when the data is available to the processor. If there is no data is available to the processor, then the processor is “starved” and can suspend operation.

A data flow graph can be paused and restarted at a later time. For the data flow graph to successfully resume processing, the state of the data flow graph at the time the data flow graph was paused can be stored and restored in a checkpointing process. The state of the data flow graph can include control signals, data, and so on, along with weights from variable nodes. In embodiments, the flow 200 includes reading a status of each variable node 230 within the data flow graph in order to confirm that no weight updates are being performed to the variable nodes. In addition, the status of each node in the data flow graph can include the status of fire and done signals, the data present at the input to a node, the data present at the output of the node, instructions in a rotating circular buffer controlling the node, and so on. Some embodiments include reading contents of an associated buffer for each variable node. In embodiments, the flow 200 includes reading the contents of a set of buffers 240 for each node within the data flow graph, wherein the checkpointing is based on a node being paused. The buffer data can include weights from variable nodes. The buffers can include input buffers or output buffers. The input buffers can include input data to a node being paused, and the output buffers can include processed or output data from the node.

The flow 200 includes storing the contents of a paused data flow graph 250. The contents of the paused data flow graph can include the current weight set loaded in each variable node of the data flow graph. The contents that are stored can include a time stamp. After finding the status of each variable node to be paused, the content of the associated buffer for each variable node can be stored in the local storage, such as SSD storage, with a time stamp. This process is repeated for every variable node in the graph. Some embodiments include storing the contents that were read in execution manager local storage. After reading all of the variable node weights, the execution manager can restart the data flow graph by issuing a run command to each of the variable nodes, and then valid data can flow into the data flow graph again. Recall that when a data flow graph is paused, the buffers associated with the nodes of the data flow graph are checkpointed. The buffers can be subsequently reloaded with the checkpointed information, where the checkpointed information can include variable node weights, input data, output data, fire and done signal statuses, and the like. In embodiments, the restarting includes issuing a run command to each node within the data flow graph. The run command can be issued by the execution manager, by a signal manager, and so on. The run command can include one or more fire signals. In further embodiments, the restarting can include providing new data to the starting node. Since the data flow graph executes when valid data is present and ready for processing, providing new data to an input node or a starting node can cause the data flow graph to resume execution. Various steps in the flow 200 may be changed in order, repeated, omitted, or the like without departing from the disclosed concepts. Various embodiments of the flow 200 can be included in a computer program product embodied in a non-transitory computer readable medium that includes code executable by one or more processors.

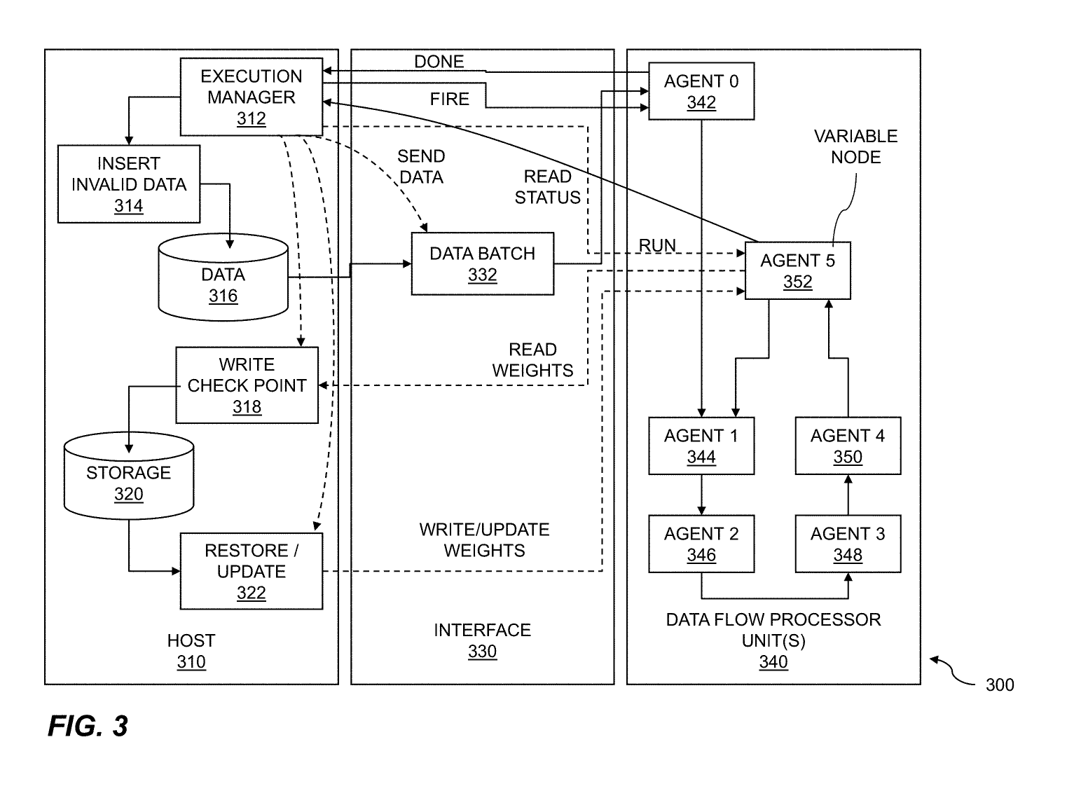

FIG. 3 shows execution manager operation. An execution manager can be associated with a data flow graph. The execution manager can perform a variety of tasks in support of the data flow graph. The tasks that can be performed by the execution manager can include providing data to input agents of the data flow graph, collecting output data from output agents, issuing fire signals to input agents of the data flow graph and receiving done signals from the input agents, sending done signals to the output agents and receiving done signals from the output agents, checkpointing data flow graph computation, pausing and restarting data flow graph execution, and so on. The execution manager can enable checkpointing data flow graph computation for machine learning.

An example of execution manager operation 300 is shown. The execution manager 312 can reside on a host 310, from which it can exert control on the flow of data 316. The host can include a computing device such as a local computer, a remote computer, a cloud-based computer, a distributed computer, a mesh computer, and so on. The computer can run any of a variety of operating systems such as Unix™, Linux™, Windows™, MacOS™, and so on. The control of the flow of data by the execution manager can be supported by inserting invalid data 314 into the data 316. When invalid data is detected, execution of the agents in support of the data flow graph can be suspended. Suspending execution of the agents can including halting or suspending the agents and vacating the agents from a reconfigurable fabric which was configured to implement the data flow graph. Since the data flow graph can be reloaded onto the reconfigurable fabric, the states of the agents and the data associated with the agents can be collected. Embodiments include checkpointing a set of buffers for each node within the data flow graph, where the checkpointing is based on a node being paused. Checkpoints that result from the checkpointing can be written 318 into storage 320. The data flow graph that was vacated can be reloaded into the reconfigurable fabric. Further embodiments include restarting a paused data flow graph, wherein the restarting is accomplished by loading a set of checkpointed buffers. The checkpointed buffers can be restored or updated 322 into the reconfigurable fabric.

Execution manager operation can include accessing an interface 330. The interface can include an interface between the host 310 and data flow processor units (DPU) 340, discussed below. The interface can include a computing device interface such as a peripheral component interconnected express (PCIe or PCI-E) interface. The interface, such as the PCIe interface, can enable transfer of one or more signals such as control signals. The control signals can include fire and done signals for controlling one or more agents, a read weights signal to capture data from agents and buffers associated with agents, such as a variable node or agent, for checkpointing, write and update weights for updating a variable node, a data batch 332 which can include data sent by the execution manager, and so on. Execution manager operation can include one or more data flow processor units 340. The data flow processor units can include one or more reconfigurable fabrics, storage, and so on. The data flow processor units can be configured to implement a data flow graph. Elements or nodes of the data flow graph, such as agents, can be loaded onto the DPUs. The agents can include agent 0 342, which can include an input node, agent 1 344, agent 2 346, agent 3 348, agent 4 350, agent 5 352, and so on. Agent 5 can be a variable node, where a variable node or other nodes can be modified based on machine learning. The variable nodes can contain weights for deep learning. While six agents are shown loaded onto the DPUs, other numbers of agents can be loaded onto the DPUs. The other numbers of agents can be based on the data flow graphs implemented on the DPUs.

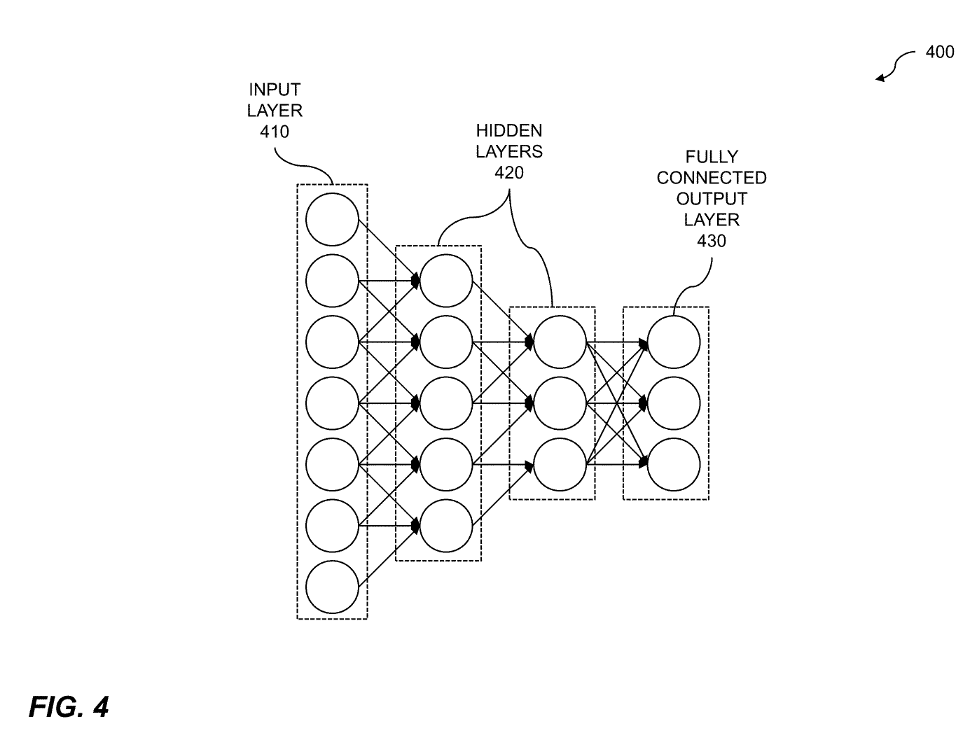

FIG. 4 shows a network for a data flow graph. A network can include a variety of portions such as interconnects, communications channels, processing elements, storage elements, and so on. A network can be implemented using one or more computing devices computational device, one or more processors, a reconfigurable fabric of processing elements, and so on. A network which can be used for executing a data flow graph can be assembled. A data flow graph is a representation of how data, such as image data, matrices, tensors, and so on, flows through a computational system. A data flow graph includes nodes and arcs, where the nodes represent operations on data, and the arcs represent the flow of data. The operations of the nodes can be implemented using agents. The data flow graph can be implemented on the network by assigning processing elements, storage elements, switching elements, etc. to nodes or agents and to arcs of the data flow graph. The network can support data flow graph computation for machine learning.

A network 400 is shown. The network includes layers, where the layers can include an input layer 410, an output layer, such as a fully connected output layer 430, and one or more hidden layers 420. The layers of the network can include one or more bottleneck layers. The network can include a deep neural network (DNN), a convolutional neural network (CNN), and so on. The network can implement a machine learning system. The input layer 410 can receive input data, where the input data can include sample data, test data, image data, audio data, matrices, tensors, and so on. The input layer can receive other data such as weights. The nodes of the input layer can perform an operation on the data, where the operation can include a multiplication, an addition, an accumulation (A=A+B), and so on. The input layer can be connected to one or more hidden layers 420. The hidden layers can perform a variety of operations on the input data and on other data such as bias values. The hidden layers can include one or more bottleneck layers. The bottleneck layer can include a layer that includes fewer nodes than the one or more preceding hidden layers. The bottleneck layer can create a constriction within the network. The bottleneck layer can force information that is pertinent to an inference, for example, into a lower dimensional representation. The one or more hidden layers can be connected to an output layer. In the example 400, the output layer can be a fully connected layer 430. In a fully connected layer, each node, agent, or neuron in a layer such as the output layer is coupled to each node of another layer. In the case of an output layer, each node of the output layer is coupled to each node of a preceding hidden layer. A fully connected layer can improve classification of data by examining all of the data in a previous layer rather than just a subset of the data. An equivalent convolutional layer can represent a fully connected layer. For computational reasons, a convolutional layer may be used in place of a fully connected layer.

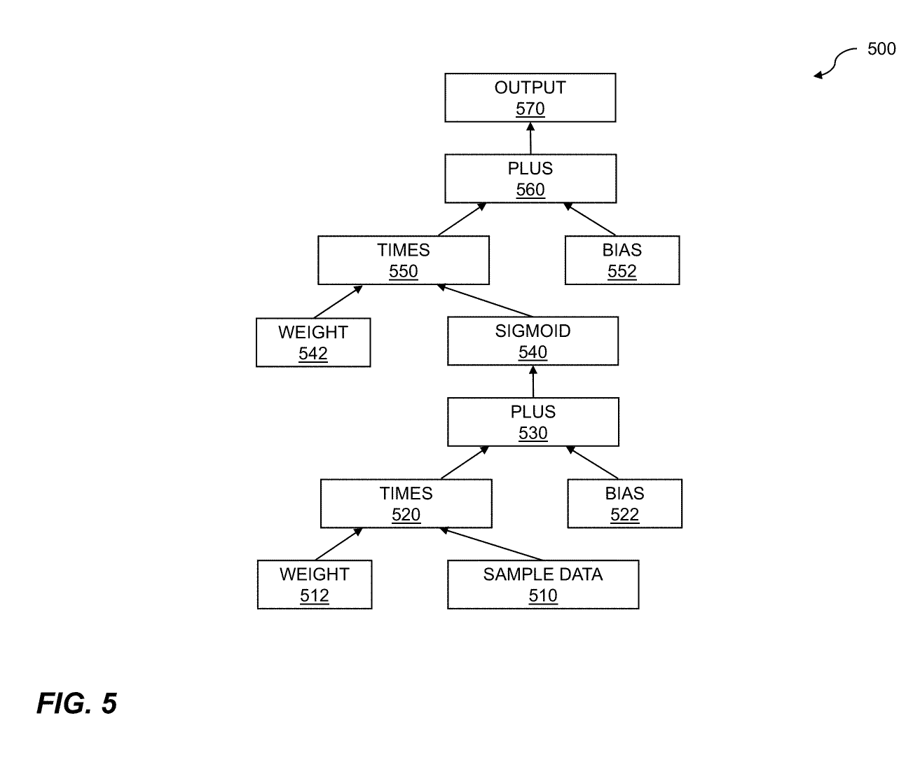

FIG. 5 illustrates a deep learning program graph. A program graph can be a computational representation of a data flow graph. The deep learning program graph can show operations and data flow for data flow graph computation for machine learning. A program graph can show the logical operations to be performed on data, and the flow of data between and among the logical operations. The program graph can show inputs, where the inputs can collect various types of data. The data can include test data, sample data, weights, biases, and so on. The program graph can show logical operations, where the logical operations can include Boolean operations, matrix operations, tensor operations, mathematical operations, and the like.

A deep learning (DL) program graph is shown 500. The deep learning program graph can include inputs and computational nodes. The inputs to the DL graph can include sample data 510 or test data, weights 512, and so on. The input data can include matrices, tensors, data files of images, and so on. The inputs can be operated on by a computation node. The computation node 520 can perform a multiplication of the weights 512 and the sample data 510. Other computational nodes can be included in the deep learning program graph. An addition node plus 530 can calculate a sum of the products or the partial products from times 520 and bias values 522. The bias values can be used to enhance performance of a deep neural network such as a DL network by improving convergence, improving inferences, etc. The one or more sums from the plus node 530 can be processed by a sigmoid node 540. A sigmoid node 540 can be used to perform an activation function such as a rectified linear unit (ReLU) operation, a hyperbolic tangent (tanh) operation, and so on. A further computation node can perform a multiplication operation, or a times 550 operation. The times operation can multiply the results of processing data with the sigmoid function by weights 542. A further computation node plus 560 can compute the sum of the products or the partial products from times 550 and bias values 552. The sums computed by plus 560 can be routed to an output node such as output node 570. Data can be collected from the output node for various purposes such as storage, processing by a further program graph, and so on.

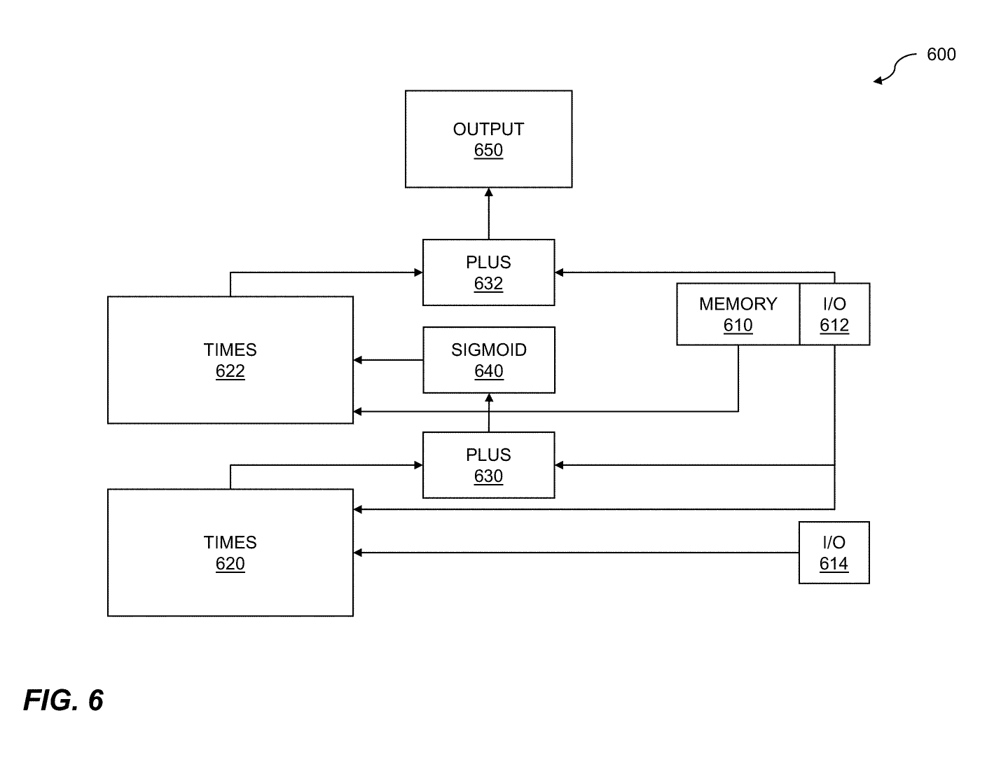

FIG. 6 shows an assembled data flow graph for runtime 600. In its most general sense, a data flow graph is an abstract construct which can describe the flow of data from one or more input nodes, through processing nodes, to one or more output nodes. The processing nodes describe operations such as logical operations, matrix operations, tensor operations, Boolean operations, etc., that can be performed on that data. The operations of the nodes can be performed by agents. To execute the data flow graph, the data flow graph can be assembled at runtime. The assembly can include configuring input/output, memory input/output, and so on. The assembled data flow graph can be executed on the data flow processor. The execution of the assembled data flow graph supports data flow graph computation for machine learning.

The techniques for assembling the data flow graph for runtime can be analogous to classic compilation of code. The steps of compilation of code can include preprocessing, compiling, assembling, linking, and so on. Inputs and outputs can be assigned to input/output ports of a computing device, a reconfigurable fabric, etc; buffers can be assigned to store, retime, or buffer data; agents can be assigned to processing elements, etc. The result of the linking can include an “execution module” or executable code that can be executed on a computing device. The executable code of the assembled data flow graph for runtime can be assigned to clusters of processing elements within the reconfigurable fabric. Processing elements of the reconfigurable fabric can be configured to implement the agents of the data flow graph by statically scheduling rotating circular buffers, where the rotating circular buffers can control the operation of the processing elements. A set of buffers can be initialized for an agent. The buffers can be located within or beyond the reconfigurable fabric.

An assembled data flow graph for runtime is shown. The assembled data flow graph can include memory 610 for storing data, intermediate results, weights, etc., input/output 612 ports, and further input/output 614 ports. The input/output ports can include assigned input/output ports of the reconfigurable fabric, communication paths through the fabric, and the like. The input/output ports can receive learning data, raw data, weights, biases, etc., and can send computation results, inferences, back-propagated weights, etc. The assembled data flow graph can include multiplication agents, such as times agent 620 and times agent 622. The times agent 620 can multiply sample data or test data by weights, the times agent 622 can multiply weights by a sigmoid function 640, and so on. The assembled data flow graph can further include addition agents, such as plus agent 630 and plus agent 632. The plus agent 630 can add partial products or products from times agent 620 to bias values. The plus agent 632 can add partial products or products from times agent 622 with bias values. The sums, partial sums, etc., that can be calculated by the add agent 632 can be output 650. The output can include computational results, inferences, weights, and so on.

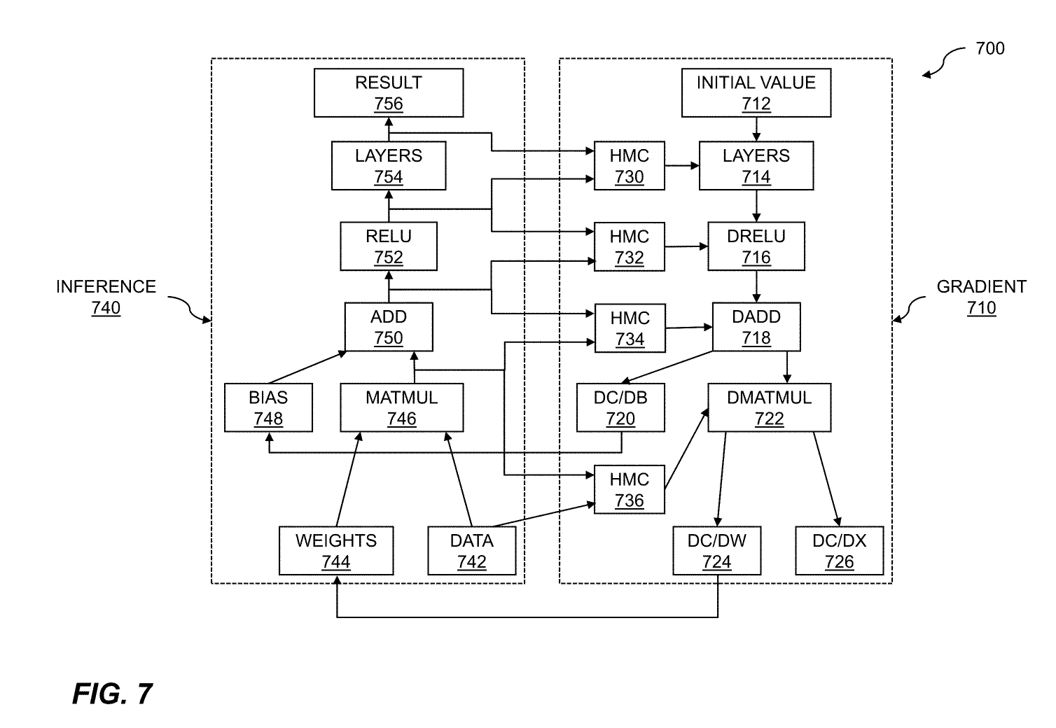

FIG. 7 illustrates batch processing for training. As discussed throughout, a data flow graph can represent a deep learning network. The deep learning network can be trained autonomously using data flow graph computation for machine learning. The training of a deep neural network (DNN) for deep learning (DL) can be an iterative process in which data from a large dataset is applied to the DNN. The data in the large dataset can be preprocessed in order to improve training of the DNN. The DNN attempts to form inferences about the data, and errors associated with the inferences can be determined. Through various techniques such as back propagation and gradient-based analysis, weights of the DNN can be updated with an adjusted weight which can be proportional to an error function.

Training of a data flow graph for deep learning is shown 700. The deep learning network can include a gradient side 710 and an inference side 740. The gradient side can be used to perform gradient descent or other techniques for error analysis to determine weights and adjustments to weights for the deep learning network. An initial value 712 can be provided at an input node of the gradient side. The initial value can be processed by layers 714 of the deep learning network, where the layers can include an input layer, hidden layers, an output layer, etc. Data such as error data from the inference side can be fed back to the gradient side by storing the data in a hybrid memory cube (HMC) 730. The data in the HMC can be fed into the layers 714 for reducing inference error. The network can include one or more differential rectified linear unit (dReLU) 716. The dReLU can execute an activation function on data received from the layers and from an HMC 732. Data can be applied to a differential addition dAdd operation 718. The dAdd operation data can also include data that can be fed back from the inference portion of the deep learning network. Data such as error data from the inference portion of the DLN can be stored in HMC 734, and the dAdd operation can process that data. An output such as dC/dB 720 can be calculated, where C can indicate a differential result, and B can indicate a bias, where the bias can enhance DNN operation. The bias can be used to enable neurons of the DNN to fire as desired even for data values near or equal to zero. The gradient portion of the DNN can include a differential matrix multiplication (dMatMul) 722 operation. The dMatMul operation can process data output from the dAdd operation and data stored in HMC 736. The data stored in the HMC can include results from an operation such as a matrix multiplication operation, training data, and so on. The dMatMul operation can generate one or more outputs such as dC/dx 726, where C can indicate a differential result, dC/dW 724, and where W can indicate a differential weight.

The inference side 740 of the DNN can take as inputs data 742 such as training data, weights 744, which can include or be adjusted by the dC/dW 724 values, and bias values 748, which can include or be adjusted by dC/dB 720 values. The weights and the data can be processed by a matrix multiplication (MatMul) operation 746. The results of the MatMul operation can be added with the bias values 748 using an addition operation 750. The results of the addition operation can be processed using an activation function such as a sigmoid function. A sigmoid function can include a rectified linear unit (ReLU) 752 where ƒ(x)=max(0,x), a hyperbolic tangent function, an error function, and so on. The inference side of the DNN can include one or more layers 754, where the layers can include an input layer, an output layer, hidden layers, a bottleneck layer, etc. The output of the DNN layers can include a result 756. The result can include an inference determined for data, training data, and the like based on an error or difference between the calculated result and an anticipated result. The training can continue until a desired level of training error such as a minimum error or target error can be attained.

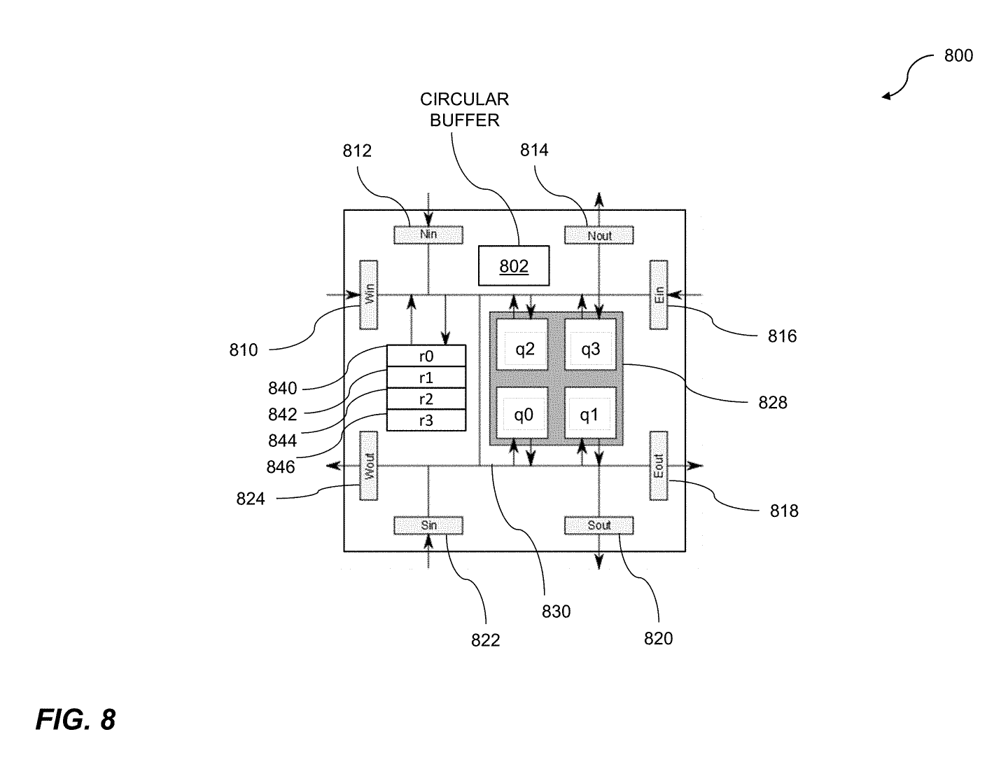

FIG. 8 shows a cluster for coarse-grained reconfigurable processing. The cluster for coarse-grained reconfigurable processing 800 can be used for data flow graph computation for machine learning. The machine learning can include accessing clusters on a reconfigurable fabric to implement the data flow graph. The processing elements such as clusters of processing elements on the reconfigurable fabric can include processing elements, switching elements, storage elements, etc. The plurality of processing elements can be loaded with a plurality of process agents. A first set of buffers can be initialized for a first process agent, where the first process agent corresponds to a starting node of the data flow graph. The first set of buffers can be loaded with valid data. A fire signal can be issued for the starting node, based on the first set of buffers being initialized.

The cluster 800 comprises a circular buffer 802. The circular buffer 802 can be referred to as a main circular buffer or a switch-instruction circular buffer. In some embodiments, the cluster 800 comprises additional circular buffers corresponding to processing elements within the cluster. The additional circular buffers can be referred to as processor instruction circular buffers. The example cluster 800 comprises a plurality of logical elements, configurable connections between the logical elements, and a circular buffer 802 controlling the configurable connections. The logical elements can further comprise one or more of switching elements, processing elements, or storage elements. The example cluster 800 also comprises four processing elements—q0, q1, q2, and q3. The four processing elements can collectively be referred to as a “quad,” and can be jointly indicated by a grey reference box 828. In embodiments, there is intercommunication among and between each of the four processing elements. In embodiments, the circular buffer 802 controls the passing of data to the quad of processing elements 828 through switching elements. In embodiments, the four processing elements 828 comprise a processing cluster. In some cases, the processing elements can be placed into a sleep state. In embodiments, the processing elements wake up from a sleep state when valid data is applied to the inputs of the processing elements. In embodiments, the individual processors of a processing cluster share data and/or instruction caches. The individual processors of a processing cluster can implement message transfer via a bus or shared memory interface. Power gating can be applied to one or more processors (e.g. q1) in order to reduce power.

The cluster 800 can further comprise storage elements coupled to the configurable connections. As shown, the cluster 800 comprises four storage elements—r0 840, r1 842, r2 844, and r3 846. The cluster 800 further comprises a north input (Nin) 812, a north output (Nout) 814, an east input (Ein) 816, an east output (Eout) 818, a south input (Sin) 822, a south output (Sout) 820, a west input (Win) 810, and a west output (Wout) 824. The circular buffer 802 can contain switch instructions that implement configurable connections. For example, an instruction effectively connects the west input 810 with the north output 814 and the east output 818 and this routing is accomplished via bus 830. The cluster 800 can further comprise a plurality of circular buffers residing on a semiconductor chip where the plurality of circular buffers controls unique, configurable connections between the logical elements. The storage elements can include instruction random access memory (I-RAM) and data random access memory (D-RAM). The I-RAM and the D-RAM can be quad I-RAM and quad D-RAM, respectively, where the I-RAM and/or the D-RAM supply instructions and/or data, respectively, to the processing quad of a switching element.

A preprocessor or compiler can be configured to prevent data collisions within the circular buffer 802. The prevention of collisions can be accomplished by inserting no-op or sleep instructions into the circular buffer (pipeline). Alternatively, in order to prevent a collision on an output port, intermediate data can be stored in registers for one or more pipeline cycles before being sent out on the output port. In other situations, the preprocessor can change one switching instruction to another switching instruction to avoid a conflict. For example, in some instances the preprocessor can change an instruction placing data on the west output 824 to an instruction placing data on the south output 820, such that the data can be output on both output ports within the same pipeline cycle. In a case where data needs to travel to a cluster that is both south and west of the cluster 800, it can be more efficient to send the data directly to the south output port rather than to store the data in a register first, and then send the data to the west output on a subsequent pipeline cycle.

An L2 switch interacts with the instruction set. A switch instruction typically has both a source and a destination. Data is accepted from the source and sent to the destination. There are several sources (e.g. any of the quads within a cluster, any of the L2 directions—North, East, South, West, a switch register, one of the quad RAMs—data RAM, IRAM, PE/Co Processor Register). As an example, to accept data from any L2 direction, a “valid” bit is used to inform the switch that the data flowing through the fabric is indeed valid. The switch will select the valid data from the set of specified inputs. For this to function properly, only one input can have valid data, and the other inputs must all be marked as invalid. It should be noted that this fan-in operation at the switch inputs operates independently for control and data. There is no requirement for a fan-in mux to select data and control bits from the same input source. Data valid bits are used to select valid data, and control valid bits are used to select the valid control input. There are many sources and destinations for the switching element, which can result in too many instruction combinations, so the L2 switch has a fan-in function enabling input data to arrive from one and only one input source. The valid input sources are specified by the instruction. Switch instructions are therefore formed by combining a number of fan-in operations and sending the result to a number of specified switch outputs.

In the event of a software error, multiple valid bits may arrive at an input. In this case, the hardware implementation can perform any safe function of the two inputs. For example, the fan-in could implement a logical OR of the input data. Any output data is acceptable because the input condition is an error, so long as no damage is done to the silicon. In the event that a bit is set to ‘1’ for both inputs, an output bit should also be set to ‘1’. A switch instruction can accept data from any quad or from any neighboring L2 switch. A switch instruction can also accept data from a register or a microDMA controller. If the input is from a register, the register number is specified. Fan-in may not be supported for many registers as only one register can be read in a given cycle. If the input is from a microDMA controller, a DMA protocol is used for addressing the resource.

For many applications, the reconfigurable fabric can be a DMA slave, which enables a host processor to gain direct access to the instruction and data RAMs (and registers) that are located within the quads in the cluster. DMA transfers are initiated by the host processor on a system bus. Several DMA paths can propagate through the fabric in parallel. The DMA paths generally start or finish at a streaming interface to the processor system bus. DMA paths may be horizontal, vertical, or a combination (as determined by a router). To facilitate high bandwidth DMA transfers, several DMA paths can enter the fabric at different times, providing both spatial and temporal multiplexing of DMA channels. Some DMA transfers can be initiated within the fabric, enabling DMA transfers between the block RAMs without external supervision. It is possible for a cluster “A”, to initiate a transfer of data between cluster “B” and cluster “C” without any involvement of the processing elements in clusters “B” and “C”. Furthermore, cluster “A” can initiate a fan-out transfer of data from cluster “B” to clusters “C”, “D”, and so on, where each destination cluster writes a copy of the DMA data to different locations within their Quad RAMs. A DMA mechanism may also be used for programming instructions into the instruction RAMs.

Accesses to RAM in different clusters can travel through the same DMA path, but the transactions must be separately defined. A maximum block size for a single DMA transfer can be 8KB. Accesses to data RAMs can be performed either when the processors are running, or while the processors are in a low power “sleep” state. Accesses to the instruction RAMs and the PE and Co-Processor Registers may be performed during configuration mode. The quad RAMs may have a single read/write port with a single address decoder, thus allowing shared access by the quads and the switches. The static scheduler (i.e. the router) determines when a switch is granted access to the RAMs in the cluster. The paths for DMA transfers are formed by the router by placing special DMA instructions into the switches and determining when the switches can access the data RAMs. A microDMA controller within each L2 switch is used to complete data transfers. DMA controller parameters can be programmed using a simple protocol that forms the “header” of each access.

In embodiments, the computations that can be performed on a cluster for coarse-grained reconfigurable processing can be represented by a data flow graph. Data flow processors, data flow processor elements, and the like, are particularly well suited to processing the various nodes of data flow graphs. The data flow graphs can represent communications between and among agents, matrix computations, tensor manipulations, Boolean functions, and so on. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of high quality data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs arranged in configurations such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value of minus one plus the Manhattan distance from a given PE in a cluster to the end of the cluster. A Manhattan distance can include a number of steps to the east, west, north, and south. A control signal can be propagated from the start cluster to the end cluster. The control signal advances 1 cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were pre-programmed configuration mode can also be pre-programmed to exit configuration mode. When configuration mode has been exited, execution of the one or more kernels loaded onto the clusters can commence.

Data flow processes that can be executed by data flow processors can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The pre-compiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as those based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

A reconfigurable fabric can include quads of elements. The elements of the reconfigurable fabric can include processing elements, switching elements, storage elements, and so on. An element such as a storage element can be controlled by a rotating circular buffer. In embodiments, the rotating circular buffer can be statically scheduled. The data operated on by the agents that are resident within the reconfigurable buffer can include tensors. Tensors can include one or more blocks. The reconfigurable fabric can be configured to process tensors, tensor blocks, tensors and blocks, etc. One technique for processing tensors includes deploying agents in a pipeline. That is, the output of one agent can be directed to the input of another agent. Agents can be assigned to clusters of quads, where the clusters can include one or more quads. Multiple agents can be pipelined when there are sufficient clusters of quads to which the agents can be assigned. Multiple pipelines can be deployed. Pipelining of the multiple agents can reduce the sizes of input buffers, output buffers, intermediate buffers, and other storage elements. Pipelining can further reduce memory bandwidth needs of the reconfigurable fabric.

Agents can be used to support dynamic reconfiguration of the reconfigurable fabric. The agents that support dynamic reconfiguration of the reconfigurable fabric can include interface signals in a control unit. The interface signals can include suspend, agent inputs empty, agent outputs empty, and so on. The suspend signal can be implemented using a variety of techniques such as a semaphore, a streaming input control signal, and the like. When a semaphore is used, the agent that is controlled by the semaphore can monitor the semaphore. In embodiments, a direct memory access (DMA) controller can wake the agent when the setting of the semaphore has been completed. The streaming control signal, if used, can wake a control unit if the control unit is sleeping. A response received from the agent can be configured to interrupt the host software.

The suspend semaphore can be asserted by runtime software in advance of commencing dynamic reconfiguration of the reconfigurable fabric. Upon detection of the semaphore, the agent can begin preparing for entry into a partially resident state. A partially resident state for the agent can include having the agent control unit resident after the agent kernel is removed. The agent can complete processing of any currently active tensor being operated on by the agent. In embodiments, a done signal and a fire signal may be sent to upstream or downstream agents, respectively. A done signal can be sent to the upstream agent to indicate that all data has been removed from its output buffer. A fire signal can be sent to a downstream agent to indicate that data in the output buffer is ready for processing by the downstream agent. The agent can continue to process incoming done signals and fire signals but will not commence processing of any new tensor data after completion of the current tensor processing by the agent. The semaphore can be reset by the agent to indicate to a host that the agent is ready to be placed into partial residency. In embodiments, having the agent control unit resident after the agent kernel is removed comprises having the agent partially resident. A control unit may not assert one or more signals, nor expect one or more responses from a kernel in the agent, when a semaphore has been reset.

Other signals from an agent can be received by a host. The signals can include an agent inputs empty signal, an agent outputs empty signal, and so on. The agent inputs empty signal can be sent from the agent to the host and can indicate that the input buffers are empty. The agent inputs empty signal can only be sent from the agent when the agent is partially resident. The agent outputs empty signal can be sent from the agent to the host and can indicate that the output buffers are empty. The agent outputs empty can only be sent from the agent to the host when the agent is partially resident. When the runtime (host) software receives both signals, agent inputs empty and agent outputs empty, from the partially resident agent, the agent can be swapped out of the reconfigurable fabric and can become fully vacant.

Recall that an agent can be one of a plurality of agents that form a data flow graph. The data flow graph can be based on a plurality of subgraphs. The data flow graph can be based on agents which can support three states of residency: fully resident, partially resident, and fully vacant. A complete subsection (or subgraph) based on the agents that support the three states of residency can be swapped out of the reconfigurable fabric. The swapping out of the subsection can be based on asserting a suspend signal input to an upstream agent. The asserting of the suspend signal can be determined by the runtime software. When a suspend signal is asserted, the agent can stop consuming input data such as an input sensor. The tensor can queue within the input buffers of the agent. The agent kernel can be swapped out of the reconfigurable fabric, leaving the agent partially resident while the agent waits for the downstream agents to drain the output buffers for the agent. When an upstream agent is fully resident, the agent may not be able to fully vacant because a fire signal might be sent to the agent by the upstream agent. When the upstream agent is partially resident or is fully vacant, then the agent can be fully vacated from the reconfigurable fabric. The agent can be fully vacated if it asserts both the input buffers empty and output buffers empty signals.

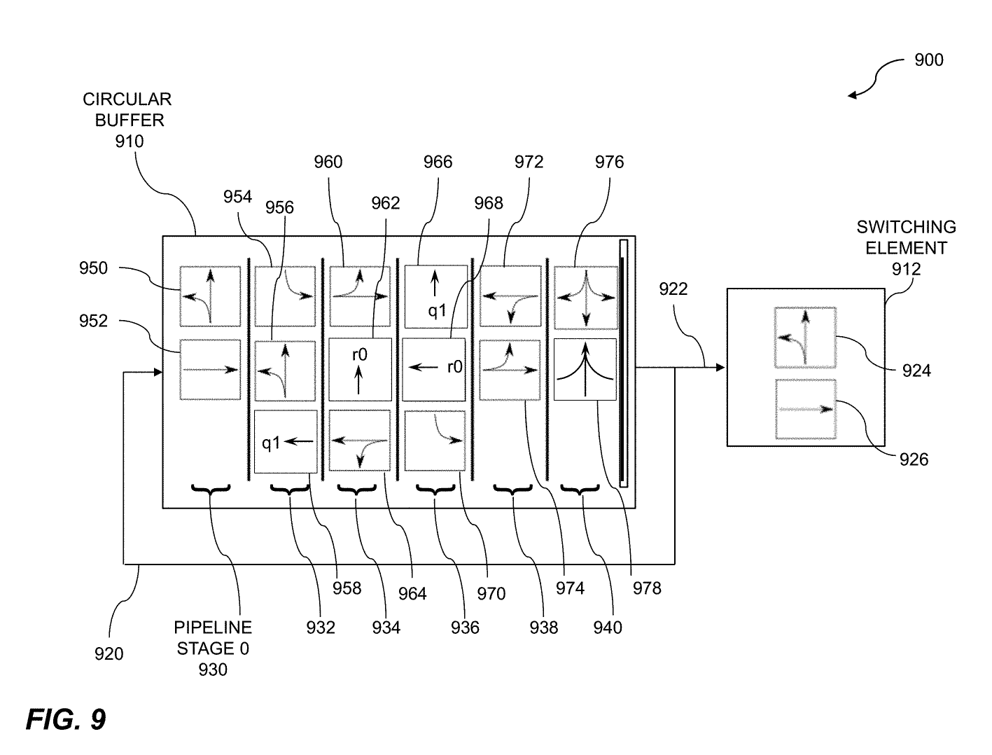

FIG. 9 shows a block diagram of a circular buffer. The circular buffer 900 can include a switching element 912 corresponding to the circular buffer. The circular buffer and the corresponding switching element can be used in part for dynamic reconfiguration using data transfer control. Using the circular buffer 910 and the corresponding switching element 912, data can be obtained from a first switching unit, where the first switching unit can be controlled by a first circular buffer. Data can be sent to a second switching element, where the second switching element can be controlled by a second circular buffer. The obtaining data from the first switching element and the sending data to the second switching element can include a direct memory access (DMA). The circular buffer 900 block diagram describes a processor-implemented method for data manipulation. The circular buffer 910 contains a plurality of pipeline stages. Each pipeline stage contains one or more instructions, up to a maximum instruction depth. In the embodiment shown in FIG. 9, the circular buffer 910 is a 6×3 circular buffer, meaning that it implements a six-stage pipeline with an instruction depth of up to three instructions per stage (column). Hence, the circular buffer 910 can include one, two, or three switch instruction entries per column. In some embodiments, the plurality of switch instructions per cycle can comprise two or three switch instructions per cycle. However, in certain embodiments, the circular buffer 910 supports only a single switch instruction in a given cycle. In the circular buffer block diagram example 900 shown, Pipeline Stage 0 930 has an instruction depth of two instructions 950 and 952. Though the remaining pipeline stages 1-5 are not textually labeled in the FIG. 900, the stages are indicated by callouts 932, 934, 936, 938, and 940. Pipeline stage 1 932 has an instruction depth of three instructions 954, 956, and 958. Pipeline stage 2 934 has an instruction depth of three instructions 960, 962, and 964. Pipeline stage 3 936 also has an instruction depth of three instructions 966, 968, and 970. Pipeline stage 4 938 has an instruction depth of two instructions 972 and 974. Pipeline stage 5 940 has an instruction depth of two instructions 976 and 978. In embodiments, the circular buffer 910 includes 64 columns. During operation, the circular buffer 910 rotates through configuration instructions. The circular buffer 910 can dynamically change operation of the logical elements based on the rotation of the circular buffer. The circular buffer 910 can comprise a plurality of switch instructions per cycle for the configurable connections.

The instruction 952 is an example of a switch instruction. In embodiments, each cluster has four inputs and four outputs, each designated within the cluster's nomenclature as “north,” “east,” “south,” and “west” respectively. For example, the instruction 952 in the diagram 900 is a west-to-east transfer instruction. The instruction 952 directs the cluster to take data on its west input and send out the data on its east output. In another example of data routing, the instruction 950 is a fan-out instruction. The instruction 950 instructs the cluster to take data from its south input and send out on the data through both its north output and its west output. The arrows within each instruction box indicate the source and destination of the data. The instruction 978 is an example of a fan-in instruction. The instruction 978 takes data from the west, south, and east inputs and sends out the data on the north output. Therefore, the configurable connections can be considered to be time multiplexed.

In embodiments, the clusters implement multiple storage elements in the form of registers. In the example 900 shown, the instruction 962 is a local storage instruction. The instruction 962 takes data from the instruction's south input and stores it in a register (r0). Another instruction (not shown) is a retrieval instruction. The retrieval instruction takes data from a register (e.g. r0) and outputs it from the instruction's output (north, south, east, west). Some embodiments utilize four general purpose registers, referred to as registers r0, r1, r2, and r3. The registers are, in embodiments, storage elements which store data while the configurable connections are busy with other data. In embodiments, the storage elements are 32-bit registers. In other embodiments, the storage elements are 64-bit registers. Other register widths are possible.

The obtaining data from a first switching element and the sending the data to a second switching element can include a direct memory access (DMA). A DMA transfer can continue while valid data is available for the transfer. A DMA transfer can terminate when it has completed without error, or when an error occurs during operation. Typically, a cluster that initiates a DMA transfer will request to be brought out of sleep state when the transfer is completed. This waking is achieved by setting control signals that can control the one or more switching elements. Once the DMA transfer is initiated with a start instruction, a processing element or switching element in the cluster can execute a sleep instruction to place itself to sleep. When the DMA transfer terminates, the processing elements and/or switching elements in the cluster can be brought out of sleep after the final instruction is executed. Note that if a control bit can be set in the register of the cluster that is operating as a slave in the transfer, that cluster can also be brought out of sleep state if it is asleep during the transfer.

The cluster that is involved in a DMA and can be brought out of sleep after the DMA terminates can determine that it has been brought out of a sleep state based on the code that is executed. A cluster can be brought out of a sleep state based on the arrival of a reset signal and the execution of a reset instruction. The cluster can be brought out of sleep by the arrival of valid data (or control) following the execution of a switch instruction. A processing element or switching element can determine why it was brought out of a sleep state by the context of the code that the element starts to execute. A cluster can be awoken during a DMA operation by the arrival of valid data. The DMA instruction can be executed while the cluster remains asleep as the cluster awaits the arrival of valid data. Upon arrival of the valid data, the cluster is woken and the data stored. Accesses to one or more data random access memories (RAM) can be performed when the processing elements and the switching elements are operating. The accesses to the data RAMs can also be performed while the processing elements and/or switching elements are in a low power sleep state.

In embodiments, the clusters implement multiple processing elements in the form of processor cores, referred to as cores q0, q1, q2, and q3. In embodiments, four cores are used, though any number of cores can be implemented. The instruction 958 is a processing instruction. The instruction 958 takes data from the instruction's east input and sends it to a processor q1 for processing. The processors can perform logic operations on the data, including, but not limited to, a shift operation, a logical AND operation, a logical OR operation, a logical NOR operation, a logical XOR operation, an addition, a subtraction, a multiplication, and a division. Thus, the configurable connections can comprise one or more of a fan-in, a fan-out, and a local storage.

In the example 900 shown, the circular buffer 910 rotates instructions in each pipeline stage into switching element 912 via a forward data path 922, and also back to a pipeline stage 0 930 via a feedback data path 920. Instructions can include switching instructions, storage instructions, and processing instructions, among others. The feedback data path 920 can allow instructions within the switching element 912 to be transferred back to the circular buffer. Hence, the instructions 924 and 926 in the switching element 912 can also be transferred back to pipeline stage 0 as the instructions 950 and 952. In addition to the instructions depicted on FIG. 9, a no-op instruction can also be inserted into a pipeline stage. In embodiments, a no-op instruction causes execution to not be performed for a given cycle. In effect, the introduction of a no-op instruction can cause a column within the circular buffer 910 to be skipped in a cycle. In contrast, not skipping an operation indicates that a valid instruction is being pointed to in the circular buffer. A sleep state can be accomplished by not applying a clock to a circuit, performing no processing within a processor, removing a power supply voltage or bringing a power supply to ground, storing information into a non-volatile memory for future use and then removing power applied to the memory, or by similar techniques. A sleep instruction that causes no execution to be performed until a predetermined event occurs which causes the logical element to exit the sleep state can also be explicitly specified. The predetermined event can be the arrival or availability of valid data. The data can be determined to be valid using null convention logic (NCL). In embodiments, only valid data can flow through the switching elements and invalid data points (Xs) are not propagated by instructions.

In some embodiments, the sleep state is exited based on an instruction applied to a switching fabric. The sleep state can, in some embodiments, only be exited by a stimulus external to the logical element and not based on the programming of the logical element. The external stimulus can include an input signal, which in turn can cause a wake up or an interrupt service request to execute on one or more of the logical elements. An example of such a wake-up request can be seen in the instruction 958, assuming that the processor q1 was previously in a sleep state. In embodiments, when the instruction 958 takes valid data from the east input and applies that data to the processor q1, the processor q1 wakes up and operates on the received data. In the event that the data is not valid, the processor q1 can remain in a sleep state. At a later time, data can be retrieved from the ql processor, e.g. by using an instruction such as the instruction 966. In the case of the instruction 966, data from the processor q1 is moved to the north output. In some embodiments, if Xs have been placed into the processor q1, such as during the instruction 958, then Xs would be retrieved from the processor q1 during the execution of the instruction 966 and would then be applied to the north output of the instruction 966.

A collision occurs if multiple instructions route data to a particular port in a given pipeline stage. For example, if instructions 952 and 954 are in the same pipeline stage, they will both send data to the east output at the same time, thus causing a collision since neither instruction is part of a time-multiplexed fan-in instruction (such as the instruction 978). To avoid potential collisions, certain embodiments use preprocessing, such as by a compiler, to arrange the instructions in such a way that there are no collisions when the instructions are loaded into the circular buffer. Thus, the circular buffer 910 can be statically scheduled in order to prevent data collisions. Thus, in embodiments, the circular buffers are statically scheduled. In embodiments, when the preprocessor detects a data collision, the scheduler changes the order of the instructions to prevent the collision. Alternatively, or additionally, the preprocessor can insert further instructions such as storage instructions (e.g. the instruction 962), sleep instructions, or no-op instructions, to prevent the collision. Alternatively, or additionally, the preprocessor can replace multiple instructions with a single fan-in instruction. For example, if a first instruction sends data from the south input to the north output and a second instruction sends data from the west input to the north output in the same pipeline stage, the first and second instruction can be replaced with a fan-in instruction that routes the data from both of those inputs to the north output in a deterministic way to avoid a data collision. In this case, the machine can guarantee that valid data is only applied on one of the inputs for the fan-in instruction.

Returning to DMA, a channel configured as a DMA channel requires a flow control mechanism that is different from regular data channels. A DMA controller can be included in interfaces to master DMA transfer through the processing elements and switching elements. For example, if a read request is made to a channel configured as DMA, the Read transfer is mastered by the DMA controller in the interface. It includes a credit count that enumerates the records in a transmit (Tx) FIFO that are known to be available. The credit count is initialized based on the size of the Tx FIFO. When a data record is removed from the Tx FIFO, the credit count is increased. If the credit count is positive, and the DMA transfer is not complete, an empty data record can be inserted into a receive (Rx) FIFO. The memory bit is set to indicate that the data record should be populated with data by the source cluster. If the credit count is zero (meaning the Tx FIFO is full), no records are entered into the Rx FIFO. The FIFO to fabric block will make sure the memory bit is reset to 0 which thereby prevents a microDMA controller in the source cluster from sending more data.

Each slave interface manages four interfaces between the FIFOs and the fabric. Each interface can contain up to 15 data channels. Therefore, a slave should manage read/write queues for up to 60 channels. Each channel can be programmed to be a DMA channel, or a streaming data channel. DMA channels are managed using a DMA protocol. Streaming data channels are expected to maintain their own form of flow control using the status of the Rx FIFOs (obtained using a query mechanism). Read requests to slave interfaces use one of the flow control mechanisms described previously.

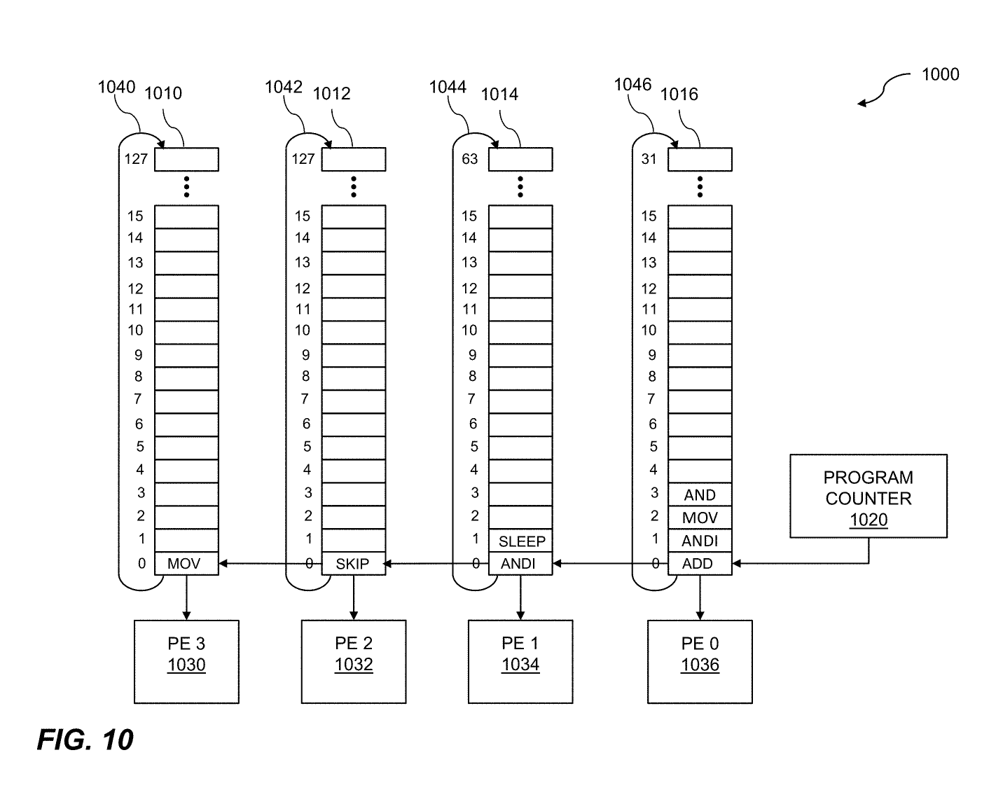

FIG. 10 illustrates circular buffers and processing elements. A diagram 1000 indicates example instruction execution for processing elements. The processing elements can include a portion of or all of the elements within a reconfigurable fabric. The instruction execution can include instructions for data flow graph computation for machine learning. A circular buffer 1010 feeds a processing element 1030. A second circular buffer 1012 feeds another processing element 1032. A third circular buffer 1014 feeds another processing element 1034. A fourth circular buffer 1016 feeds another processing element 1036. The four processing elements 1030, 1032, 1034, and 1036 can represent a quad of processing elements. In embodiments, the processing elements 1030, 1032, 1034, and 1036 are controlled by instructions received from the circular buffers 1010, 1012, 1014, and 1016. The circular buffers can be implemented using feedback paths 1040, 1042, 1044, and 1046, respectively. In embodiments, the circular buffer can control the passing of data to a quad of processing elements through switching elements, where each of the quad of processing elements is controlled by four other circular buffers (as shown in the circular buffers 1010, 1012, 1014, and 1016) and where data is passed back through the switching elements from the quad of processing elements where the switching elements are again controlled by the main circular buffer. In embodiments, a program counter 1020 is configured to point to the current instruction within a circular buffer. In embodiments with a configured program counter, the contents of the circular buffer are not shifted or copied to new locations on each instruction cycle. Rather, the program counter 1020 is incremented in each cycle to point to a new location in the circular buffer. The circular buffers 1010, 1012, 1014, and 1016 can contain instructions for the processing elements. The instructions can include, but are not limited to, move instructions, skip instructions, logical AND instructions, logical AND-Invert (e.g. ANDI) instructions, logical OR instructions, mathematical ADD instructions, shift instructions, sleep instructions, and so on. A sleep instruction can be usefully employed in numerous situations. The sleep state can be entered by an instruction within one of the processing elements. One or more of the processing elements can be in a sleep state at any given time. In some embodiments, a “skip” can be performed on an instruction and the instruction in the circular buffer can be ignored and the corresponding operation not performed.

The plurality of circular buffers can have differing lengths. That is, the plurality of circular buffers can comprise circular buffers of differing sizes. In embodiments, the circular buffers 1010 and 1012 have a length of 128 instructions, the circular buffer 1014 has a length of 64 instructions, and the circular buffer 1016 has a length of 32 instructions, but other circular buffer lengths are also possible, and in some embodiments, all buffers have the same length. The plurality of circular buffers that have differing lengths can resynchronize with a zeroth pipeline stage for each of the plurality of circular buffers. The circular buffers of differing sizes can restart at a same time step. In other embodiments, the plurality of circular buffers includes a first circular buffer repeating at one frequency and a second circular buffer repeating at a second frequency. In this situation, the first circular buffer is of one length. When the first circular buffer finishes through a loop, it can restart operation at the beginning, even though the second, longer circular buffer has not yet completed its operations. When the second circular buffer reaches completion of its loop of operations, the second circular buffer can restart operations from its beginning.

As can be seen in FIG. 10, different circular buffers can have different instruction sets within them. For example, circular buffer 1010 contains a MOV instruction. Circular buffer 1012 contains a SKIP instruction. Circular buffer 1014 contains a SLEEP instruction and an ANDI instruction. Circular buffer 1016 contains an AND instruction, a MOVE instruction, an ANDI instruction, and an ADD instruction. The operations performed by the processing elements 1030, 1032, 1034, and 1036 are dynamic and can change over time, based on the instructions loaded into the respective circular buffers. As the circular buffers rotate, new instructions can be executed by the respective processing element.

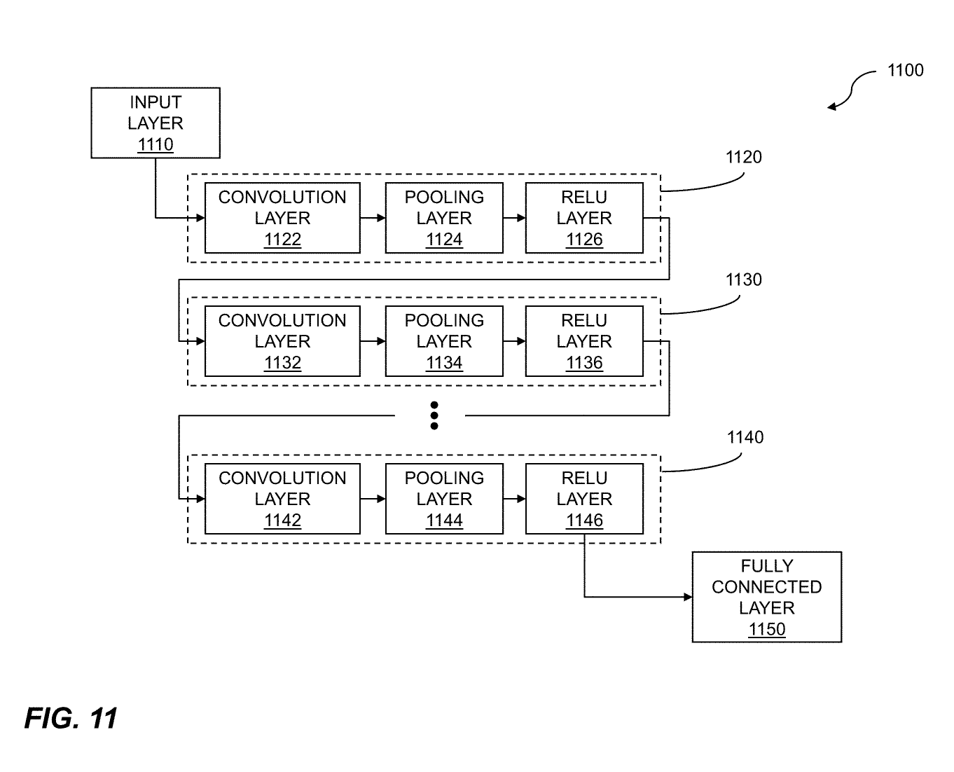

FIG. 11 shows a deep learning block diagram. The deep learning block diagram 1100 can include a neural network such as a deep neural network (DNN), a convolutional neural network (CNN), and so on. In embodiments, the neural network comprises a recurrent neural network. A recurrent neural network is a type of neural network in which the connections can direct cycle paths within the neural network. A convolutional neural network can be based on layers, where the layers can include input layers, output layers, fully connected layers, convolution layers, pooling layers, rectified linear unit (ReLU) layers, and so on. The layers of the convolutional network can be implemented using a reconfigurable fabric. The reconfigurable fabric can include processing elements, switching elements, storage elements, etc. The reconfigurable fabric can be used to perform various operations such as logical operations. Deep learning can be applied to data flow graph computation for machine learning.

A deep learning block diagram 1100 is shown. The block diagram can include various layers, where the layers can include an input layer, hidden layers, a fully connected layer, and so on. In some embodiments, the deep learning block diagram can include a classification layer. The input layer 1110 can receive input data, where the input data can include a first collected data group, a second collected data group, a third collected data group, a fourth collected data group, etc. The collecting of the data groups can be performed in a first locality, a second locality, a third locality, a fourth locality, and so on, respectively. The input layer can then perform processing such as partitioning collected data into non-overlapping partitions. The deep learning block diagram 1100, which can represent a network such as a convolutional neural network, can contain a plurality of hidden layers. While three hidden layers, hidden layer 1120, hidden layer 1130, and hidden layer 1140 are shown, other numbers of hidden layers may be present. Each hidden layer can include layers that perform various operations, where the various layers can include a convolution layer, a pooling layer, and a rectifier layer such as a rectified linear unit (ReLU) layer. Thus, layer 1120 can include convolution layer 1122, pooling layer 1124, and ReLU layer 1126; layer 1130 can include convolution layer 1132, pooling layer 1134, and ReLU layer 1136; and layer 1140 can include convolution layer 1142, pooling layer 1144, and ReLU layer 1146. The convolution layers 1122, 1132, and 1142 can perform convolution operations; the pooling layers 1124, 1134, and 1144 can perform pooling operations, including max pooling, such as data down-sampling; and the ReLU layers 1126, 1136, and 1146 can perform rectification operations. A convolutional layer can reduce the amount of data feeding into a fully connected layer. The deep learning block diagram 1100 can include a fully connected layer 1150. The fully connected layer can be connected to each data point from the one or more convolutional layers.

Data flow processors can be implemented within a reconfigurable fabric. Data flow processors can be applied to many applications where large amounts of data such as unstructured data are processed. Typical processing applications for unstructured data can include speech and image recognition, natural language processing, bioinformatics, customer relationship management, digital signal processing (DSP), graphics processing (GP), network routing, telemetry such as weather data, data warehousing, and so on. Data flow processors can be programmed using software and can be applied to highly advanced problems in computer science such as deep learning. Deep learning techniques can include an artificial neural network, a convolutional neural network, etc. The success of these techniques is highly dependent on large quantities of data for training and learning. The data-driven nature of these techniques is well suited to implementations based on data flow processors. The data flow processor can receive a data flow graph such as an acyclic data flow graph, where the data flow graph can represent a deep learning network. The data flow graph can be assembled at runtime, where assembly can include input/output, memory input/output, and so on. The assembled data flow graph can be executed on the data flow processor.

The data flow processors can be organized in a variety of configurations. One configuration can include processing element quads with arithmetic units. A data flow processor can include one or more processing elements (PE). The processing elements can include a processor, a data memory, an instruction memory, communications capabilities, and so on. Multiple PEs can be grouped, where the groups can include pairs, quads, octets, etc. The PEs configured in arrangements such as quads can be coupled to arithmetic units, where the arithmetic units can be coupled to or included in data processing units (DPU). The DPUs can be shared between and among quads. The DPUs can provide arithmetic techniques to the PEs, communications between quads, and so on.

The data flow processors, including data flow processors arranged in quads, can be loaded with kernels. The kernels can be included in a data flow graph, for example. In order for the data flow processors to operate correctly, the quads can require reset and configuration modes. Processing elements can be configured into clusters of PEs. Kernels can be loaded onto PEs in the cluster, where the loading of kernels can be based on availability of free PEs, an amount of time to load the kernel, an amount of time to execute the kernel, and so on. Reset can begin with initializing up-counters coupled to PEs in a cluster of PEs. Each up-counter is initialized with a value minus one plus the Manhattan distance from a given PE in a cluster to the end of the cluster. A Manhattan distance can include a number of steps to the east, west, north, and south. A control signal can be propagated from the start cluster to the end cluster. The control signal advances one cluster per cycle. When the counters for the PEs all reach 0 then the processors have been reset. The processors can be suspended for configuration, where configuration can include loading of one or more kernels onto the cluster. The processors can be enabled to execute the one or more kernels. Configuring mode for a cluster can include propagating a signal. Clusters can be preprogrammed to enter configuration mode. A configuration mode can be entered. Various techniques, including direct memory access (DMA) can be used to load instructions from the kernel into instruction memories of the PEs. The clusters that were pre-programmed into configuration mode can be preprogrammed to exit configuration mode. When configuration mode has been exited, execution of the one or more kernels loaded onto the clusters can commence.

Data flow processes that can be executed by data flow processor can be managed by a software stack. A software stack can include a set of subsystems, including software subsystems, which may be needed to create a software platform. The software platform can include a complete software platform. A complete software platform can include a set of software subsystems required to support one or more applications. A software stack can include both offline and online operations. Offline operations can include software subsystems such as compilers, linkers, simulators, emulators, and so on. The offline software subsystems can be included in a software development kit (SDK). The online operations can include data flow partitioning, data flow graph throughput optimization, and so on. The online operations can be executed on a session host and can control a session manager. Online operations can include resource management, monitors, drivers, etc. The online operations can be executed on an execution engine. The online operations can include a variety of tools which can be stored in an agent library. The tools can include BLAS™, CONV2D™, SoftMax™, and so on.

Software to be executed on a data flow processor can include precompiled software or agent generation. The pre-compiled agents can be stored in an agent library. An agent library can include one or more computational models which can simulate actions and interactions of autonomous agents. Autonomous agents can include entities such as groups, organizations, and so on. The actions and interactions of the autonomous agents can be simulated to determine how the agents can influence operation of a whole system. Agent source code can be provided from a variety of sources. The agent source code can be provided by a first entity, provided by a second entity, and so on. The source code can be updated by a user, downloaded from the Internet, etc. The agent source code can be processed by a software development kit, where the software development kit can include compilers, linkers, assemblers, simulators, debuggers, and so on. The agent source code that can be operated on by the software development kit (SDK) can be in an agent library. The agent source code can be created using a variety of tools, where the tools can include MATMUL™, Batchnorm™, Relu™, and so on. The agent source code that has been operated on can include functions, algorithms, heuristics, etc., that can be used to implement a deep learning system.

A software development kit can be used to generate code for the data flow processor or processors. The software development kit (SDK) can include a variety of tools which can be used to support a deep learning technique or other technique which requires processing of large amounts of data such as unstructured data. The SDK can support multiple machine learning techniques such as machine learning techniques based on GAMM, sigmoid, and so on. The SDK can include a low-level virtual machine (LLVM) which can serve as a front end to the SDK. The SDK can include a simulator. The SDK can include a Boolean satisfiability solver (SAT solver). The SAT solver can include a compiler, a linker, and so on. The SDK can include an architectural simulator, where the architectural simulator can simulate a data flow processor or processors. The SDK can include an assembler, where the assembler can be used to generate object modules. The object modules can represent agents. The agents can be stored in a library of agents. Other tools can be included in the SDK. The various techniques of the SDK can operate on various representations of a wave flow graph (WFG).

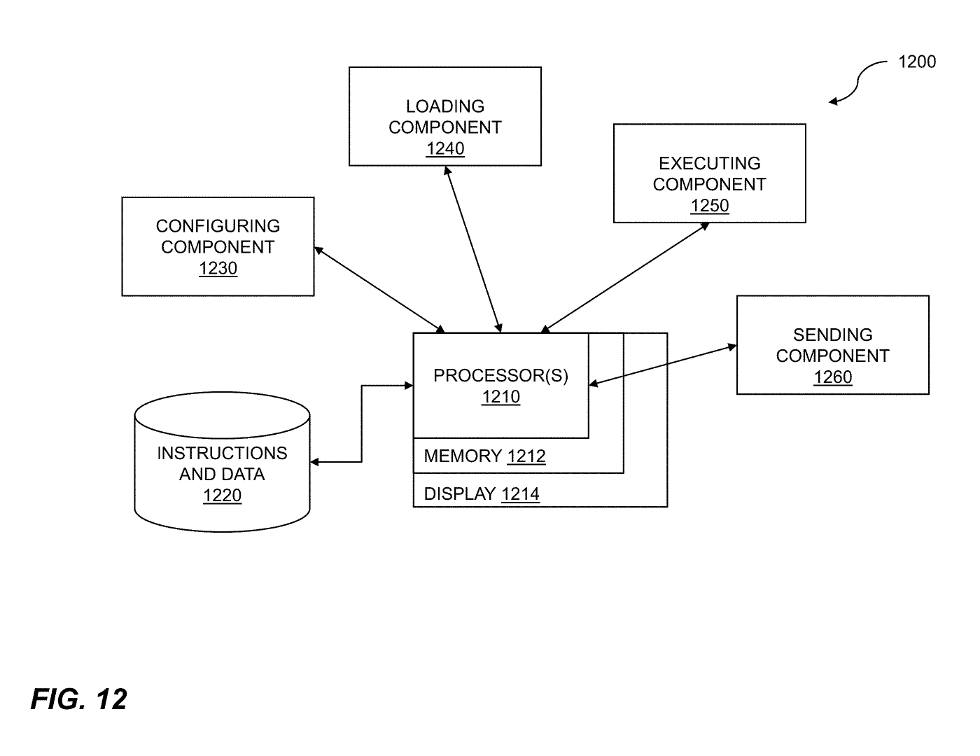

FIG. 12 is a system diagram for checkpointing data flow graph computation for machine learning. The system 1200 can include one or more processors 1210 coupled to a memory 1212 which stores instructions. The system 1200 can include a display 1214 coupled to the one or more processors 1210 for displaying data, intermediate steps, instructions, and so on. In embodiments, one or more processors 1210 are attached to the memory 1212 where the one or more processors, when executing the instructions which are stored, are configured to: configure a plurality of processing elements within a reconfigurable fabric to implement a data flow graph; load the plurality of processing elements with a plurality of process agents; execute valid data by a first process agent, wherein the first process agent corresponds to a starting node of the data flow graph; and send invalid data to the first process agent, wherein the invalid data initiates a checkpoint operation for the data flow graph.

The system 1200 can include a collection of instructions and data 1220. The instructions and data 1220 may be stored in a database, one or more statically linked libraries, one or more dynamically linked libraries, precompiled headers, source code, flow graphs, kernels, agents, or other suitable formats. The instructions can include instructions for data flow graph computation for machine learning. The data can include unstructured data, matrices, tensors, layers, and weights that can be associated with a convolutional neural network, etc. The instructions can include a static schedule for controlling one or more rotating circular buffers. The system 1200 can include a configuring component 1230. The configuring component 1230 can include functions, instructions, or code for configuring a plurality of processing elements within a reconfigurable fabric to implement a data flow graph. The plurality of processing elements can include clusters of processing elements. The clusters on the reconfigurable fabric can include quads of elements such as processing elements. The reconfigurable fabric can further include other elements such as storage elements, switching elements, and the like.

The system 1200 can include a loading component 1240. The loading component 1240 can include functions and instructions for loading the plurality of processing elements with a plurality of process agents. The process agents can be configured to perform logical operations such as Boolean operations, matrix operations, tensor operations, mathematical operations, and so on, where the logical operations are related to the data flow graph. The loading of the plurality of processing elements can be reconfigured, where the reconfiguring can be based on processing needs of the agents of the data flow graph, processing element availability, an amount of processing time, and so on. In embodiments, the reconfiguring and the loading can be controlled by a session manager or an execution manager. The session manager can partition the data flow graph and can map the partitions to processing elements of the reconfigurable fabric. The execution manager can reside outside of the reconfigurable fabric. The execution manager and the session manager can be distinct or can be combined into a single code image.

The system 1200 can include an executing component 1250. The executing component 1250 can execute valid data by a first process agent, wherein the first process agent corresponds to a starting node of the data flow graph. The executing component 1250 can include sending control signals to the processing elements, such as a fire signal or a run command, to initiate execution of the data flow graph starting node processing. The starting node can have a first process agent loaded on it. The starting node can then signal child nodes to begin their own execution based on valid data being presented from the starting node to the child node or nodes. The child nodes can include variable nodes, which can have their weights updated. The executing component 1250 can include functions and instructions for initializing a first set of buffers for a first process agent, where the first process agent corresponds to a starting node of the data flow graph. The initializing the first set of buffers can include initializing the first set of buffers with valid data. The valid data can include matrices, submatrices, tensors, tensor rows, tensor columns, etc. The first set of buffers can include storage elements, where the storage elements can include storage elements within the reconfigurable, storage beyond the reconfigurable fabric, and so on.

The system 1200 can include a sending component 1260. The sending component 1260 can include functions and instructions for sending invalid data to the starting node. An agent that receives invalid data can initiate a checkpoint operation for the data flow graph. A checkpoint operation can include reading weights from variable nodes within the data flow graph, storing the weights, timestamping the weights, updating the weights, and then restoring the weights to one or more variable nodes within the data flow graph for subsequent restarting of the process agents of the data flow graph.

The system 1200 can include a computer program product embodied in a non-transitory computer readable medium for data manipulation, the computer program product comprising code which causes one or more processors to perform operations of: configuring a plurality of processing elements within a reconfigurable fabric to implement a data flow graph; loading the plurality of processing elements with a plurality of process agents; executing valid data by a first process agent, wherein the first process agent corresponds to a starting node of the data flow graph; and sending invalid data to the first process agent, wherein the invalid data initiates a checkpoint operation for the data flow graph.

The system 1200 can comprise a computer system for data manipulation comprising: a memory which stores instructions; one or more processors attached to the memory wherein the one or more processors, when executing the instructions which are stored, are configured to: configure a plurality of processing elements within a reconfigurable fabric to implement a data flow graph; load the plurality of processing elements with a plurality of process agents; execute valid data by a first process agent, wherein the first process agent corresponds to a starting node of the data flow graph; and send invalid data to the first process agent, wherein the invalid data initiates a checkpoint operation for the data flow graph.

Each of the above methods may be executed on one or more processors on one or more computer systems. Embodiments may include various forms of distributed computing, client/server computing, and cloud-based computing. Further, it will be understood that the depicted steps or boxes contained in this disclosure's flow charts are solely illustrative and explanatory. The steps may be modified, omitted, repeated, or re-ordered without departing from the scope of this disclosure. Further, each step may contain one or more sub-steps. While the foregoing drawings and description set forth functional aspects of the disclosed systems, no particular implementation or arrangement of software and/or hardware should be inferred from these descriptions unless explicitly stated or otherwise clear from the context. All such arrangements of software and/or hardware are intended to fall within the scope of this disclosure.

The block diagrams and flowchart illustrations depict methods, apparatus, systems, and computer program products. The elements and combinations of elements in the block diagrams and flow diagrams, show functions, steps, or groups of steps of the methods, apparatus, systems, computer program products and/or computer-implemented methods. Any and all such functions—generally referred to herein as a “circuit,” “module,” or “system”—may be implemented by computer program instructions, by special-purpose hardware-based computer systems, by combinations of special purpose hardware and computer instructions, by combinations of general purpose hardware and computer instructions, and so on.

A programmable apparatus which executes any of the above-mentioned computer program products or computer-implemented methods may include one or more microprocessors, microcontrollers, embedded microcontrollers, programmable digital signal processors, programmable devices, programmable gate arrays, programmable array logic, memory devices, application specific integrated circuits, or the like. Each may be suitably employed or configured to process computer program instructions, execute computer logic, store computer data, and so on.

It will be understood that a computer may include a computer program product from a computer-readable storage medium and that this medium may be internal or external, removable and replaceable, or fixed. In addition, a computer may include a Basic Input/Output System (BIOS), firmware, an operating system, a database, or the like that may include, interface with, or support the software and hardware described herein.

Embodiments of the present invention are limited to neither conventional computer applications nor the programmable apparatus that run them. To illustrate: the embodiments of the presently claimed invention could include an optical computer, quantum computer, analog computer, or the like. A computer program may be loaded onto a computer to produce a particular machine that may perform any and all of the depicted functions. This particular machine provides a means for carrying out any and all of the depicted functions.

Any combination of one or more computer readable media may be utilized including but not limited to: a non-transitory computer readable medium for storage; an electronic, magnetic, optical, electromagnetic, infrared, or semiconductor computer readable storage medium or any suitable combination of the foregoing; a portable computer diskette; a hard disk; a random access memory (RAM); a read-only memory (ROM), an erasable programmable read-only memory (EPROM, Flash, MRAM, FeRAM, or phase change memory); an optical fiber; a portable compact disc; an optical storage device; a magnetic storage device; or any suitable combination of the foregoing. In the context of this document, a computer readable storage medium may be any tangible medium that can contain or store a program for use by or in connection with an instruction execution system, apparatus, or device.

It will be appreciated that computer program instructions may include computer executable code. A variety of languages for expressing computer program instructions may include without limitation C, C++, Java, JavaScript™, ActionScript™, assembly language, Lisp, Perl, Tcl, Python, Ruby, hardware description languages, database programming languages, functional programming languages, imperative programming languages, and so on. In embodiments, computer program instructions may be stored, compiled, or interpreted to run on a computer, a programmable data processing apparatus, a heterogeneous combination of processors or processor architectures, and so on. Without limitation, embodiments of the present invention may take the form of web-based computer software, which includes client/server software, software-as-a-service, peer-to-peer software, or the like.

In embodiments, a computer may enable execution of computer program instructions including multiple programs or threads. The multiple programs or threads may be processed approximately simultaneously to enhance utilization of the processor and to facilitate substantially simultaneous functions. By way of implementation, any and all methods, program codes, program instructions, and the like described herein may be implemented in one or more threads which may in turn spawn other threads, which may themselves have priorities associated with them. In some embodiments, a computer may process these threads based on priority or other order.

Unless explicitly stated or otherwise clear from the context, the verbs “execute” and “process” may be used interchangeably to indicate execute, process, interpret, compile, assemble, link, load, or a combination of the foregoing. Therefore, embodiments that execute or process computer program instructions, computer-executable code, or the like may act upon the instructions or code in any and all of the ways described. Further, the method steps shown are intended to include any suitable method of causing one or more parties or entities to perform the steps. The parties performing a step, or portion of a step, need not be located within a particular geographic location or country boundary. For instance, if an entity located within the United States causes a method step, or portion thereof, to be performed outside of the United States then the method is considered to be performed in the United States by virtue of the causal entity.

While the invention has been disclosed in connection with preferred embodiments shown and described in detail, various modifications and improvements thereon will become apparent to those skilled in the art. Accordingly, the foregoing examples should not limit the spirit and scope of the present invention; rather it should be understood in the broadest sense allowable by law.

What is claimed is:

1. A processor-implemented method for data manipulation comprising:
configuring a plurality of processing elements within a reconfigurable fabric to implement a data flow graph;
loading the plurality of processing elements with a plurality of process agents;
executing valid data by a first process agent, wherein the first process agent corresponds to a starting node of the data flow graph; and
sending invalid data to the first process agent, wherein the invalid data initiates a checkpoint operation for the data flow graph.

2. The method of claim 1 wherein one or more nodes of the data flow graph comprise variable nodes.

3. The method of claim 2 wherein the variable nodes are paused upon receiving invalid data.

4. The method of claim 2 wherein the variable nodes contain weights.

5-6. (canceled)

7. The method of claim 2 further comprising propagating invalid data from the starting node of the data flow graph to other nodes within the data flow graph.

8. The method of claim 7 further comprising pausing each variable node within the data flow graph upon receipt of invalid data.

9. The method of claim 8 further comprising reading a status of each variable node within the data flow graph.

10. The method of claim 9 further comprising reading contents of an associated buffer for each variable node.

11. The method of claim 10 further comprising storing the contents that were read in execution manager local storage.

12. (canceled)

13. The method of claim 2 further comprising writing weights to each of the variable nodes.

14. The method of claim 13 further comprising restarting variable nodes within the data flow graph that are paused by issuing a run command to all variable nodes that are paused.

15. The method of claim 14 further comprising sending valid data to the starting node of the data flow graph.

16. (canceled)

17. The method of claim 1 wherein the invalid data is sent by an execution manager.

18. The method of claim 17 wherein the execution manager is part of a host outside of the reconfigurable fabric.

19-21. (canceled)

22. The method of claim 1 wherein the reconfiguring, the loading, and the sending are controlled by an execution manager.

23. The method of claim 1 wherein the processing elements are controlled by circular buffers.

24-27. (canceled)

28. The method of claim 1 wherein the reconfigurable fabric is self-clocked on a hum basis.

29. (canceled)

30. The method of claim 1 wherein the invalid data comprises data with an invalid bit set.

31. The method of claim 1 wherein the checkpoint operation includes storing variable node weights in storage outside of the reconfigurable fabric.

32. The method of claim 31 wherein the weights are read and stored from variable node buffers.

33. The method of claim 1 wherein the checkpoint operation is managed by an execution manager.

34. A computer program product embodied in a non-transitory computer readable medium for data manipulation, the computer program product comprising code which causes one or more processors to perform operations of:
configuring a plurality of processing elements within a reconfigurable fabric to implement a data flow graph;
loading the plurality of processing elements with a plurality of process agents;
executing valid data by a first process agent, wherein the first process agent corresponds to a starting node of the data flow graph; and
sending invalid data to the first process agent, wherein the invalid data initiates a checkpoint operation for the data flow graph.

35. A computer system for data manipulation comprising:
a memory which stores instructions;
one or more processors attached to the memory wherein the one or more processors, when executing the instructions which are stored, are configured to:
configure a plurality of processing elements within a reconfigurable fabric to implement a data flow graph;
load the plurality of processing elements with a plurality of process agents;
execute valid data by a first process agent, wherein the first process agent corresponds to a starting node of the data flow graph; and
send invalid data to the first process agent, wherein the invalid data initiates a checkpoint operation for the data flow graph.
